(19) United States
(12) Patent Application Publication
(10) Pub. No.: US 2025/0055943 A1
(43) Pub. Date: Feb. 13, 2025

(54) APPARATUS, METHOD, AND COMPUTER PROGRAM FOR A COMMUNICATION SYSTEM

(71) Applicant: Nokia Technologies Oy, Espoo (FI)

(72) Inventors: Shohreh AHVAR, Massy (FR); Dinh Thai BUI, Massy (FR); Ehsan AHVAR, Massy (FR); Joao Antonio PEREIRA RODRIGUES, Amadora (PT); Laurent THIÉBAUT, Massy (FR); Laurent GOIX, Massy (FR); Gerald KUNZMANN, Munich (DE)

(21) Appl. No.: 18/797,263

(22) Filed: Aug. 7, 2024

(30) Foreign Application Priority Data
Aug. 10, 2023 (GB) 2312255.9

(51) Int. Cl. H04M 15/00; H04W 4/24; H04W 28/02

(52) U.S. Cl. CPC H04M 15/66; H04M 15/8228; H04W 4/24; H04W 28/0221

(57) ABSTRACT

There is provided an apparatus, method, and computer program for causing an apparatus to perform: mapping an energy behaviour category to a user equipment, wherein the energy behaviour category is an energy behaviour category of a plurality of energy behaviour categories defined by a network operator that categorizes how energy efficiently an apparatus is behaving; and providing an indication of the mapped energy behaviour category to a requesting network function.

### CROSS-REFERENCE TO RELATED APPLICATIONS

This application claims the benefit of priority of United Kingdom Patent Application No. 2312255.9, filed Aug. 10, 2023, which is hereby incorporated by reference.

### FIELD

The examples described herein generally relate to apparatus, methods, and computer programs, and more particularly (but not exclusively) to apparatus, methods and computer programs for communication systems.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite-based communication systems and different wireless local networks, for example wireless local area networks (WLAN). The wireless systems can typically be divided into cells and are therefore often referred to as cellular systems.

The communication system and associated devices typically operate in accordance with a given standard or specification which sets out what the various entities associated with the system are permitted to do and how that should be achieved. Communication protocols and/or parameters which shall be used for the connection are also typically defined. Examples of standard are the so-called 5G standards.

### SUMMARY

According to a first aspect, there is provided an apparatus comprising means for performing: mapping an energy behaviour category to a user equipment, wherein the energy behaviour category is an energy behaviour category of a plurality of energy behaviour categories defined by a network operator that categorizes how energy efficiently an apparatus is behaving; and providing an indication of the mapped energy behaviour category to a requesting network function.

The apparatus may further comprise means for performing: receiving at least one of an identifier of the user equipment or an identifier of a group of user equipment that comprises the user equipment, the apparatus further comprising means for performing: receiving in a request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category; and using the received indication to perform analytics that determines the mapped energy behaviour category.

The apparatus may further comprise means for performing: using the mapped energy behaviour category to adjust at least one charging policy associated with a session of the user equipment.

The means for using the mapped energy behaviour to adjust the at least one charging policy may comprise means for performing: using the mapped energy behaviour category to look up at least one energy credit charging policy associated with the mapped energy behaviour category; and adjusting at least one charging policy to comply with the at least one energy credit charging policy.

The apparatus may further comprise means for performing: determining at least one action that may be performed by the user equipment and/or a user of the user equipment for making the user equipment perform in a more energy efficient energy behaviour category than the determined energy behaviour category; and causing an indication of the at least one action to be signalled to the requesting network function.

The apparatus may be comprised in a network data analytics function and/or a charging function.

The requesting network function may be comprised at least one of: a policy control function, a charging function, a session management function, or an access and mobility management function.

According to a second aspect, there is provided an apparatus comprising means for performing: determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and providing, to a network function, at least one policy for the user equipment determined in dependence on the determined energy behaviour category.

The network function may be an access and mobility function, and/or a session management function, and/or a charging function.

The means for determining whether a policy is to be generated based on the energy behaviour category may comprise means for performing: retrieving at least one of: an indication of an energy behaviour category associated with the user equipment, or an indication of a network slice; and using the retrieved indication to perform the determining.

When the network function comprises a session management function, the at least one policy provided to a session management function may comprise an indication that at least one policy for the user equipment is based on the energy behaviour category associated with the user equipment or a group of user equipments.

The apparatus may further comprise means for performing: receiving the energy behaviour category associated with that subscriber from an analytics function and/or from a charging function.

The apparatus may further comprise means for performing: providing a session management function with the received energy behaviour category associated with that subscriber.

The apparatus may be comprised in a policy control function.

According to a third aspect, there is provided an apparatus comprising means for performing: receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving; and enforcing, for a session associated with the user equipment, at least one policy that complies with the energy behaviour category associated with that subscriber.

The apparatus may further comprise means for performing receiving the energy behaviour category associated with the user equipment from a policy and control function.

The apparatus may further comprise means for performing: receiving the energy behaviour category associated with the user equipment from a charging function and/or an analytics function.

The apparatus may further comprise means for performing: selecting a user plane function for the user equipment using the energy behaviour category associated with the user equipment.

The apparatus may further comprise means for performing: modifying a session management policy based on the energy behaviour category associated with the user equipment.

The apparatus may further comprise means for performing: inserting the energy behaviour category associated with the user equipment into at least one charging data request; and signalling the at least one charging data request to a charging function.

The apparatus may be comprised in a session management function.

The network function may be at least one of a policy and control function, a charging function, and a network analytics function.

According to a fourth aspect, there is provided an apparatus comprising means for performing: obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and using the energy behaviour category associated with the user equipment to determine a charging policy for the user equipment.

The means for obtaining may comprise means for: receiving the energy behaviour category associated with that subscriber from a session management function and/or from an analytics function, and/or from a policy control function.

The means for using the mapped energy behaviour to determine the at least one charging policy may comprise means for performing: using the energy behaviour category to look up at least one energy credit charging policy associated with the mapped energy behaviour category; and setting at least one charging policy to comply with the at least one energy credit charging policy.

The apparatus may further comprise means for performing: determining at least one action that may be performed by the user equipment and/or a user of the user equipment for making the user equipment perform in a more energy efficient energy behaviour category than the determined energy behaviour category; and causing an indication of the at least one action to be signalled to the user equipment.

The apparatus may be comprised in a charging function.

According to a fifth aspect, there is provided an apparatus comprising means for performing: receiving, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category; and causing the first set of user equipment to change their operating configuration to cause the first set of user equipment to operate more energy efficiently.

The apparatus may further comprise means for performing: determining that the operation of the first set of user equipment has changed to an extent that the first set of user equipment are associated with the second energy behaviour category.

The apparatus may be comprised in a network exposure function and/or an application function.

According to a sixth aspect, there is provided an apparatus comprising means for performing: receiving, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving; and causing a change in operating configuration at the apparatus in response to said receiving.

The means for causing the change may comprise means for: causing an output to be displayed to a user of the apparatus that indicates at least one of: the first energy behaviour category, or at least one mechanism by which the operations of the apparatus may be performed more energy efficiently; subsequently determining that a behaviour of the user has changed; and providing an indication of the change in behaviour to a network.

The means for causing the change may comprise means for: receiving an indication of a change to at least one operating characteristic of the apparatus; and causing the change to the at least one operating characteristic to be performed.

According to a seventh aspect, there is provided an apparatus comprising: at least one processor; and at least one memory comprising code that, when executed by the at least one processor, causes the apparatus to perform: mapping an energy behaviour category to a user equipment, wherein the energy behaviour category is an energy behaviour category of a plurality of energy behaviour categories defined by a network operator that categorizes how energy efficiently an apparatus is behaving; and providing an indication of the mapped energy behaviour category to a requesting network function.

The apparatus may further be caused to perform: receiving at least one of an identifier of the user equipment or an identifier of a group of user equipment that comprises the user equipment, the apparatus further being caused to perform: receiving in a request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category; and using the received indication to perform analytics that determines the mapped energy behaviour category.

The apparatus may further be caused to perform: using the mapped energy behaviour category to adjust at least one charging policy associated with a session of the user equipment.

The using the mapped energy behaviour to adjust the at least one charging policy may comprise performing: using the mapped energy behaviour category to look up at least one energy credit charging policy associated with the mapped energy behaviour category; and adjusting at least one charging policy to comply with the at least one energy credit charging policy.

The apparatus may further be caused to perform: determining at least one action that may be performed by the user equipment and/or a user of the user equipment for making the user equipment perform in a more energy efficient energy behaviour category than the determined energy behaviour category; and causing an indication of the at least one action to be signalled to the requesting network function.

The apparatus may be comprised in a network data analytics function and/or a charging function.

The requesting network function may be comprised at least one of: a policy control function, a charging function, a session management function, or an access and mobility management function.

According to an eighth aspect, there is provided an apparatus comprising: at least one processor; and at least one memory comprising code that, when executed by the at least one processor, causes the apparatus to perform: determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and providing, to a network function, at least one policy for the user equipment determined in dependence on the determined energy behaviour category.

The network function may be an access and mobility function, and/or a session management function, and/or a charging function.

The determining whether a policy is to be generated based on the energy behaviour category may comprise performing: retrieving at least one of: an indication of an energy behaviour category associated with the user equipment, or an indication of a network slice; and using the retrieved indication to perform the determining.

When the network function comprises a session management function, the at least one policy provided to a session management function may comprise an indication that at least one policy for the user equipment is based on the energy behaviour category associated with the user equipment or a group of user equipments.

The apparatus may further be caused to perform: receiving the energy behaviour category associated with that subscriber from an analytics function and/or from a charging function.

The apparatus may further be caused to perform: providing a session management function with the received energy behaviour category associated with that subscriber.

The apparatus may be comprised in a policy control function.

According to a ninth aspect, there is provided an apparatus comprising: at least one processor; and at least one memory comprising code that, when executed by the at least one processor, causes the apparatus to perform: receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving; and enforcing, for a session associated with the user equipment, at least one policy that complies with the energy behaviour category associated with that subscriber.

The apparatus may further be caused to perform receiving the energy behaviour category associated with the user equipment from a policy and control function.

The apparatus may further be caused to perform: receiving the energy behaviour category associated with the user equipment from a charging function and/or an analytics function.

The apparatus may further be caused to perform: selecting a user plane function for the user equipment using the energy behaviour category associated with the user equipment.

The apparatus may further be caused to perform: modifying a session management policy based on the energy behaviour category associated with the user equipment.

The apparatus may further be caused to perform: inserting the energy behaviour category associated with the user equipment into at least one charging data request; and signalling the at least one charging data request to a charging function.

The apparatus may be comprised in a session management function.

The network function may be at least one of a policy and control function, a charging function, and a network analytics function.

According to a tenth aspect, there is provided an apparatus comprising: at least one processor; and at least one memory comprising code that, when executed by the at least one processor, causes the apparatus to perform: obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and using the energy behaviour category associated with the user equipment to determine a charging policy for the user equipment.

The obtaining may comprise: receiving the energy behaviour category associated with that subscriber from a session management function and/or from an analytics function, and/or from a policy control function.

The using the mapped energy behaviour to determine the at least one charging policy may comprise performing: using the energy behaviour category to look up at least one energy credit charging policy associated with the mapped energy behaviour category; and setting at least one charging policy to comply with the at least one energy credit charging policy.

The apparatus may further be caused to perform: determining at least one action that may be performed by the user equipment and/or a user of the user equipment for making the user equipment perform in a more energy efficient energy behaviour category than the determined energy behaviour category; and causing an indication of the at least one action to be signalled to the user equipment.

The apparatus may be comprised in a charging function.

According to an eleventh aspect, there is provided an apparatus comprising: at least one processor; and at least one memory comprising code that, when executed by the at least one processor, causes the apparatus to perform: receiving, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category; and causing the first set of user equipment to change their operating configuration to cause the first set of user equipment to operate more energy efficiently.

The apparatus may further be caused to perform: determining that the operation of the first set of user equipment has changed to an extent that the first set of user equipment are associated with the second energy behaviour category.

The apparatus may be comprised in a network exposure function and/or an application function.

According to a twelfth aspect, there is provided an apparatus comprising: at least one processor; and at least one memory comprising code that, when executed by the at least one processor, causes the apparatus to perform: receiving, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving; and causing a change in operating configuration at the apparatus in response to said receiving.

The causing the change may comprise: causing an output to be displayed to a user of the apparatus that indicates at least one of: the first energy behaviour category, or at least one mechanism by which the operations of the apparatus may be performed more energy efficiently; subsequently determining that a behaviour of the user has changed; and providing an indication of the change in behaviour to a network.

The causing the change may comprise: receiving an indication of a change to at least one operating characteristic of the apparatus; and causing the change to the at least one operating characteristic to be performed.

According to a thirteenth aspect, there is provided a method for an apparatus, the method comprising: mapping an energy behaviour category to a user equipment, wherein the energy behaviour category is an energy behaviour category of a plurality of energy behaviour categories defined by a network operator that categorizes how energy efficiently an apparatus is behaving; and providing an indication of the mapped energy behaviour category to a requesting network function.

The method may further comprise: receiving at least one of an identifier of the user equipment or an identifier of a group of user equipment that comprises the user equipment, the method further comprising: receiving in a request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category; and using the received indication to perform analytics that determines the mapped energy behaviour category.

The method may further comprise: using the mapped energy behaviour category to adjust at least one charging policy associated with a session of the user equipment.

The using the mapped energy behaviour to adjust the at least one charging policy may comprise performing: using the mapped energy behaviour category to look up at least one energy credit charging policy associated with the mapped energy behaviour category; and adjusting at least one charging policy to comply with the at least one energy credit charging policy.

The method may further comprise: determining at least one action that may be performed by the user equipment and/or a user of the user equipment for making the user equipment perform in a more energy efficient energy behaviour category than the determined energy behaviour category; and causing an indication of the at least one action to be signalled to the requesting network function.

The apparatus may be comprised in a network data analytics function and/or a charging function.

The requesting network function may be comprised at least one of: a policy control function, a charging function, a session management function, or an access and mobility management function.

According to a fourteenth aspect, there is provided a method for an apparatus, the method comprising: determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and providing, to a network function, at least one policy for the user equipment determined in dependence on the determined energy behaviour category.

The network function may be an access and mobility function, and/or a session management function, and/or a charging function.

The determining whether a policy is to be generated based on the energy behaviour category may comprise performing: retrieving at least one of: an indication of an energy behaviour category associated with the user equipment, or an indication of a network slice; and using the retrieved indication to perform the determining.

When the network function comprises a session management function, the at least one policy provided to a session management function may comprise an indication that at least one policy for the user equipment is based on the energy behaviour category associated with the user equipment or a group of user equipments.

The method may further comprise: receiving the energy behaviour category associated with that subscriber from an analytics function and/or from a charging function.

The method may further comprise: providing a session management function with the received energy behaviour category associated with that subscriber.

The apparatus may be comprised in a policy control function.

According to a fifteenth aspect, there is provided a method for an apparatus, the method comprising: receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving; and enforcing, for a session associated with the user equipment, at least one policy that complies with the energy behaviour category associated with that subscriber.

The method may further comprise receiving the energy behaviour category associated with the user equipment from a policy and control function.

The method may further comprise: receiving the energy behaviour category associated with the user equipment from a charging function and/or an analytics function.

The method may further comprise: selecting a user plane function for the user equipment using the energy behaviour category associated with the user equipment.

The method may further comprise: modifying a session management policy based on the energy behaviour category associated with the user equipment.

The method may further comprise: inserting the energy behaviour category associated with the user equipment into at least one charging data request; and signalling the at least one charging data request to a charging function.

The apparatus may be comprised in a session management function.

The network function may be at least one of a policy and control function, a charging function, and a network analytics function.

According to a sixteenth aspect, there is provided a method for an apparatus, the method comprising: obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and using the energy behaviour category associated with the user equipment to determine a charging policy for the user equipment.

The method may further comprise for: receiving the energy behaviour category associated with that subscriber from a session management function and/or from an analytics function, and/or from a policy control function.

The using the mapped energy behaviour to determine the at least one charging policy may comprise performing: using the energy behaviour category to look up at least one energy credit charging policy associated with the mapped energy behaviour category; and setting at least one charging policy to comply with the at least one energy credit charging policy.

The method may further comprise: determining at least one action that may be performed by the user equipment and/or a user of the user equipment for making the user equipment perform in a more energy efficient energy behaviour category than the determined energy behaviour category; and causing an indication of the at least one action to be signalled to the user equipment.

The apparatus may be comprised in a charging function.

According to a seventeenth aspect, there is provided a method for an apparatus, the method comprising: receiving, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category; and causing the first set of user equipment to change their operating configuration to cause the first set of user equipment to operate more energy efficiently.

The method may further comprise: determining that the operation of the first set of user equipment has changed to an extent that the first set of user equipment are associated with the second energy behaviour category.

The apparatus may be comprised in a network exposure function and/or an application function.

According to an eighteenth aspect, there is provided a method for an apparatus, the method comprising: receiving, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving; and causing a change in operating configuration at the apparatus in response to said receiving.

The causing the change may comprise: causing an output to be displayed to a user of the apparatus that indicates at least one of: the first energy behaviour category, or at least one mechanism by which the operations of the apparatus may be performed more energy efficiently; subsequently determining that a behaviour of the user has changed; and providing an indication of the change in behaviour to a network.

The causing the change may comprise: receiving an indication of a change to at least one operating characteristic of the apparatus; and causing the change to the at least one operating characteristic to be performed.

According to a nineteenth aspect, there is provided an apparatus comprising: mapping circuitry for mapping an energy behaviour category to a user equipment, wherein the energy behaviour category is an energy behaviour category of a plurality of energy behaviour categories defined by a network operator that categorizes how energy efficiently an apparatus is behaving; and providing circuitry for providing an indication of the mapped energy behaviour category to a requesting network function.

The apparatus may further comprising: receiving circuitry for receiving at least one of an identifier of the user equipment or an identifier of a group of user equipment that comprises the user equipment, the apparatus further comprising: receiving circuitry for receiving in a request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category; and using circuitry for using the received indication to perform analytics that determines the mapped energy behaviour category.

The apparatus may further comprise: using circuitry for using the mapped energy behaviour category to adjust at least one charging policy associated with a session of the user equipment.

The using circuitry for using the mapped energy behaviour to adjust the at least one charging policy may comprise: using circuitry for using the mapped energy behaviour category to look up at least one energy credit charging policy associated with the mapped energy behaviour category; and adjusting circuitry for adjusting at least one charging policy to comply with the at least one energy credit charging policy.

The apparatus may further comprise: determining circuitry for determining at least one action that may be performed by the user equipment and/or a user of the user equipment for making the user equipment perform in a more energy efficient energy behaviour category than the determined energy behaviour category; and causing circuitry for causing an indication of the at least one action to be signalled to the requesting network function.

The apparatus may be comprised in a network data analytics function and/or a charging function.

The requesting network function may be comprised at least one of: a policy control function, a charging function, a session management function, or an access and mobility management function.

According to a twentieth aspect, there is provided an apparatus comprising: determining circuitry for determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and providing circuitry for providing, to a network function, at least one policy for the user equipment determined in dependence on the determined energy behaviour category.

The network function may be an access and mobility function, and/or a session management function, and/or a charging function.

The determining circuitry for determining whether a policy is to be generated based on the energy behaviour category may comprise: retrieving circuitry for retrieving at least one of: an indication of an energy behaviour category associated with the user equipment, or an indication of a network slice; and using circuitry for using the retrieved indication to perform the determining.

When the network function comprises a session management function, the at least one policy provided to a session management function may comprise an indication that at least one policy for the user equipment is based on the energy behaviour category associated with the user equipment or a group of user equipments.

The apparatus may further comprise: receiving circuitry for receiving the energy behaviour category associated with that subscriber from an analytics function and/or from a charging function.

The apparatus may further comprise: providing circuitry for providing a session management function with the received energy behaviour category associated with that subscriber.

The apparatus may be comprised in a policy control function.

According to a twenty first aspect, there is provided an apparatus comprising: receiving circuitry for receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving; and enforcing circuitry for enforcing, for a session associated with the user equipment, at least one policy that complies with the energy behaviour category associated with that subscriber.

The apparatus may further comprise receiving circuitry for receiving the energy behaviour category associated with the user equipment from a policy and control function.

The apparatus may further comprise: receiving circuitry for receiving the energy behaviour category associated with the user equipment from a charging function and/or an analytics function.

The apparatus may further comprise: selecting circuitry for selecting a user plane function for the user equipment using the energy behaviour category associated with the user equipment.

The apparatus may further: modifying circuitry for modifying a session management policy based on the energy behaviour category associated with the user equipment.

The apparatus may further comprise: inserting circuitry for inserting the energy behaviour category associated with the user equipment into at least one charging data request; and signalling circuitry for signalling the at least one charging data request to a charging function.

The apparatus may be comprised in a session management function.

The network function may be at least one of a policy and control function, a charging function, and a network analytics function.

According to a twenty second aspect, there is provided an apparatus comprising: obtaining circuitry for obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and using circuitry for using the energy behaviour category associated with the user equipment to determine a charging policy for the user equipment.

The obtaining circuitry for obtaining may comprise: receiving circuitry for receiving the energy behaviour category associated with that subscriber from a session management function and/or from an analytics function, and/or from a policy control function.

The using circuitry for using the mapped energy behaviour to determine the at least one charging policy may comprise: using circuitry for using the energy behaviour category to look up at least one energy credit charging policy associated with the mapped energy behaviour category; and setting circuitry for setting at least one charging policy to comply with the at least one energy credit charging policy.

The apparatus may further comprise: determining circuitry for determining at least one action that may be performed by the user equipment and/or a user of the user equipment for making the user equipment perform in a more energy efficient energy behaviour category than the determined energy behaviour category; and causing circuitry for causing an indication of the at least one action to be signalled to the user equipment.

The apparatus may be comprised in a charging function.

According to a twenty third aspect, there is provided an apparatus comprising: receiving circuitry for receiving, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category; and causing circuitry for causing the first set of user equipment to change their operating configuration to cause the first set of user equipment to operate more energy efficiently.

The apparatus may further comprise: determining circuitry for determining that the operation of the first set of user equipment has changed to an extent that the first set of user equipment are associated with the second energy behaviour category.

The apparatus may be comprised in a network exposure function and/or an application function.

According to a twenty fourth aspect, there is provided an apparatus comprising: receiving circuitry for receiving, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving; and causing circuitry for causing a change in operating configuration at the apparatus in response to said receiving.

The causing circuitry for causing the change may comprise: causing circuitry for causing an output to be displayed to a user of the apparatus that indicates at least one of: the first energy behaviour category, or at least one mechanism by which the operations of the apparatus may be performed more energy efficiently; determining circuitry for subsequently determining that a behaviour of the user has changed; and providing circuitry for providing an indication of the change in behaviour to a network.

The causing circuitry for causing the change may comprise receiving circuitry for receiving an indication of a change to at least one operating characteristic of the apparatus; and causing the change to the at least one operating characteristic to be performed.

According to a twenty fifth aspect, there is provided non-transitory computer readable medium comprising program instructions for causing an apparatus to perform: mapping an energy behaviour category to a user equipment, wherein the energy behaviour category is an energy behaviour category of a plurality of energy behaviour categories defined by a network operator that categorizes how energy efficiently an apparatus is behaving; and providing an indication of the mapped energy behaviour category to a requesting network function.

The apparatus may further be caused to perform: receiving at least one of an identifier of the user equipment or an identifier of a group of user equipment that comprises the user equipment, the apparatus further being caused to perform: receiving in a request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category; and using the received indication to perform analytics that determines the mapped energy behaviour category.

The apparatus may further be caused to perform: using the mapped energy behaviour category to adjust at least one charging policy associated with a session of the user equipment.

The using the mapped energy behaviour to adjust the at least one charging policy may comprise performing: using the mapped energy behaviour category to look up at least one energy credit charging policy associated with the mapped energy behaviour category; and adjusting at least one charging policy to comply with the at least one energy credit charging policy.

The apparatus may further be caused to perform: determining at least one action that may be performed by the user equipment and/or a user of the user equipment for making the user equipment perform in a more energy efficient energy behaviour category than the determined energy behaviour category; and causing an indication of the at least one action to be signalled to the requesting network function.

The apparatus may be comprised in a network data analytics function and/or a charging function.

The requesting network function may be comprised at least one of: a policy control function, a charging function, a session management function, or an access and mobility management function.

According to a twenty sixth aspect, there is provided non-transitory computer readable medium comprising program instructions for causing an apparatus to perform: determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and providing, to a network function, at least one policy for the user equipment determined in dependence on the determined energy behaviour category.

The network function may be an access and mobility function, and/or a session management function, and/or a charging function.

The determining whether a policy is to be generated based on the energy behaviour category may comprise performing: retrieving at least one of: an indication of an energy behaviour category associated with the user equipment, or an indication of a network slice; and using the retrieved indication to perform the determining.

When the network function comprises a session management function, the at least one policy provided to a session management function may comprise an indication that at least one policy for the user equipment is based on the energy behaviour category associated with the user equipment or a group of user equipments.

The apparatus may further be caused to perform: receiving the energy behaviour category associated with that subscriber from an analytics function and/or from a charging function.

The apparatus may further be caused to perform: providing a session management function with the received energy behaviour category associated with that subscriber.

The apparatus may be comprised in a policy control function.

According to a twenty seventh aspect, there is provided non-transitory computer readable medium comprising program instructions for causing an apparatus to perform: receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving; and enforcing, for a session associated with the user equipment, at least one policy that complies with the energy behaviour category associated with that subscriber.

The apparatus may further be caused to perform receiving the energy behaviour category associated with the user equipment from a policy and control function.

The apparatus may further be caused to perform: receiving the energy behaviour category associated with the user equipment from a charging function and/or an analytics function.

The apparatus may further be caused to perform: selecting a user plane function for the user equipment using the energy behaviour category associated with the user equipment.

The apparatus may further be caused to perform: modifying a session management policy based on the energy behaviour category associated with the user equipment.

The apparatus may further be caused to perform: inserting the energy behaviour category associated with the user equipment into at least one charging data request; and signalling the at least one charging data request to a charging function.

The apparatus may be comprised in a session management function.

The network function may be at least one of a policy and control function, a charging function, and a network analytics function.

According to a twenty eighth aspect, there is provided non-transitory computer readable medium comprising program instructions for causing an apparatus to perform: obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and using the energy behaviour category associated with the user equipment to determine a charging policy for the user equipment.

The obtaining may comprise: receiving the energy behaviour category associated with that subscriber from a session management function and/or from an analytics function, and/or from a policy control function.

The using the mapped energy behaviour to determine the at least one charging policy may comprise performing: using the energy behaviour category to look up at least one energy credit charging policy associated with the mapped energy behaviour category; and setting at least one charging policy to comply with the at least one energy credit charging policy.

The apparatus may further be caused to perform: determining at least one action that may be performed by the user equipment and/or a user of the user equipment for making the user equipment perform in a more energy efficient energy behaviour category than the determined energy behaviour category; and causing an indication of the at least one action to be signalled to the user equipment.

The apparatus may be comprised in a charging function.

According to a twenty ninth aspect, there is provided non-transitory computer readable medium comprising program instructions for causing an apparatus to perform: receiving, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category; and causing the first set of user equipment to change their operating configuration to cause the first set of user equipment to operate more energy efficiently.

The apparatus may further be caused to perform: determining that the operation of the first set of user equipment has changed to an extent that the first set of user equipment are associated with the second energy behaviour category.

The apparatus may be comprised in a network exposure function and/or an application function.

According to a thirtieth aspect, there is provided non-transitory computer readable medium comprising program instructions for causing an apparatus to perform: receiving, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving; and causing a change in operating configuration at the apparatus in response to said receiving.

The causing the change may comprise: causing an output to be displayed to a user of the apparatus that indicates at least one of: the first energy behaviour category, or at least one mechanism by which the operations of the apparatus may be performed more energy efficiently; subsequently determining that a behaviour of the user has changed; and providing an indication of the change in behaviour to a network.

The causing the change may comprise: receiving an indication of a change to at least one operating characteristic of the apparatus; and causing the change to the at least one operating characteristic to be performed.

According to a thirty first aspect, there is provided a computer program product stored on a medium that may cause an apparatus to perform any method as described herein.

According to a thirty second aspect, there is provided an electronic device that may comprise apparatus as described herein.

According to a thirty third aspect, there is provided a chipset that may comprise an apparatus as described herein.

### BRIEF DESCRIPTION OF FIGS

Some examples, will now be described, merely by way of illustration only, with reference to the accompanying drawings in which:

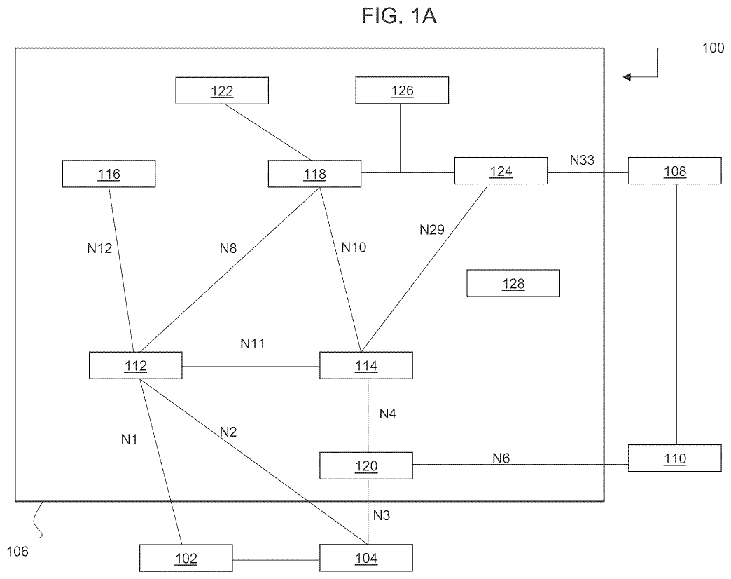

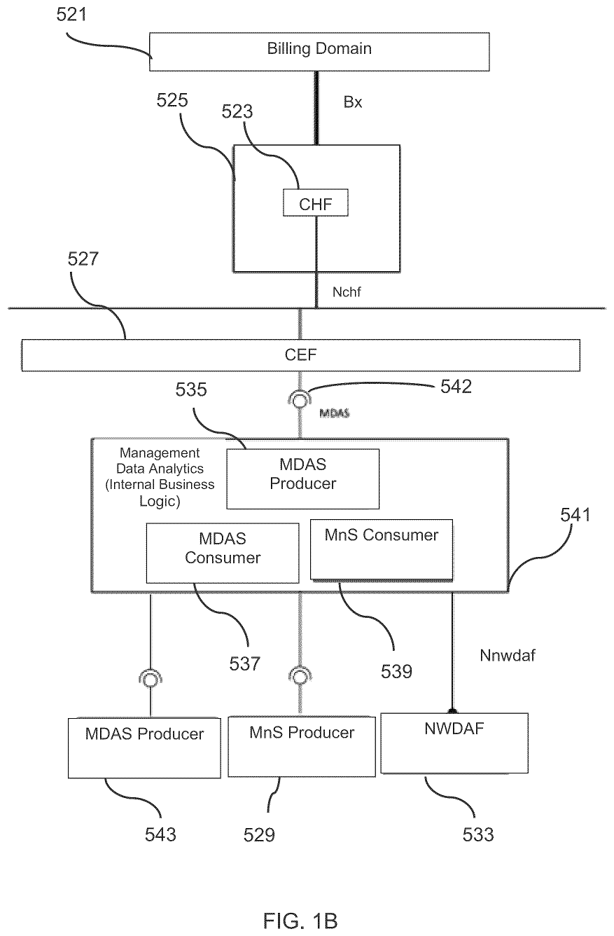

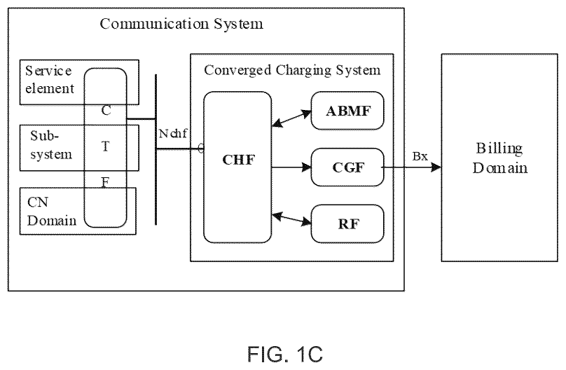

FIGS. 1A to 1C show a schematic representation of a 5G system;

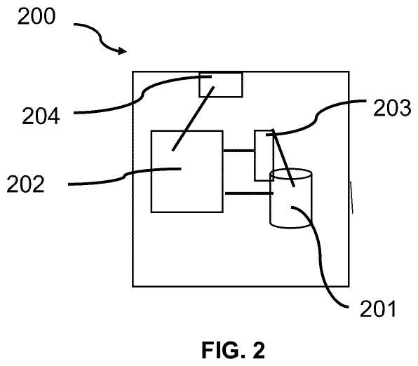

FIG. 2 shows a schematic representation of a network apparatus;

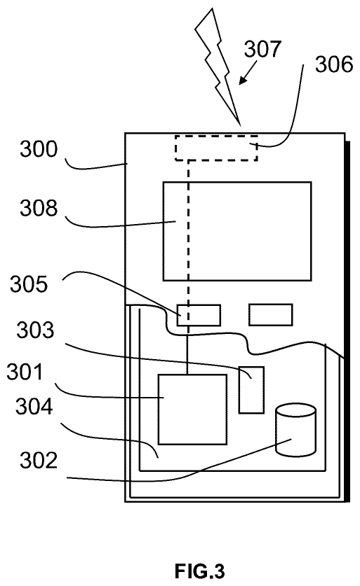

FIG. 3 shows a schematic representation of a user equipment;

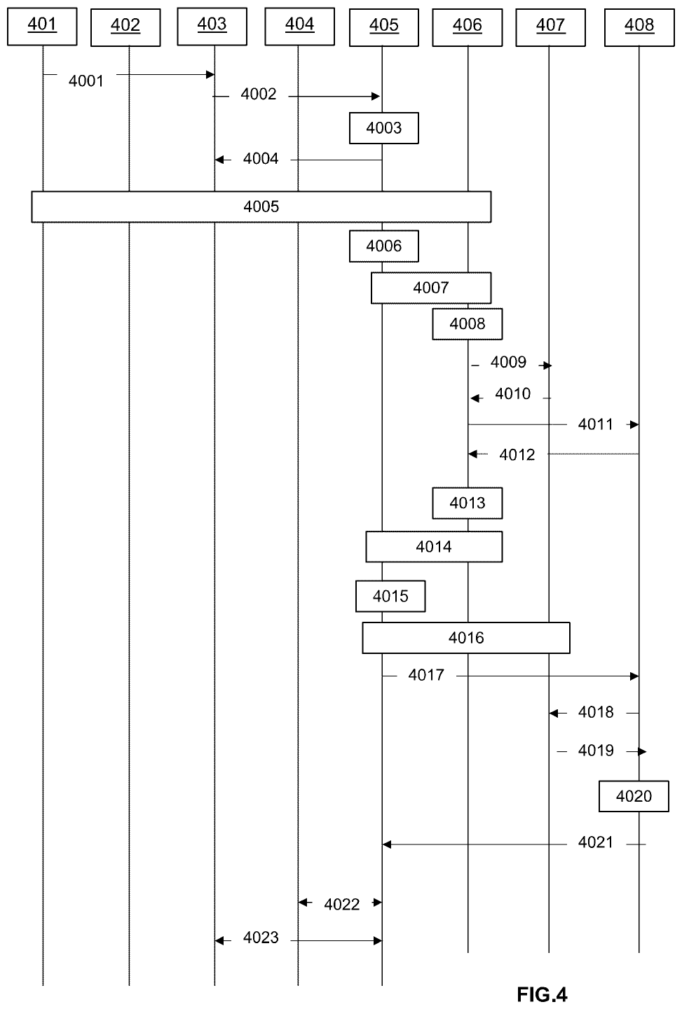

FIGS. 4 and 5 illustrate example signalling; and

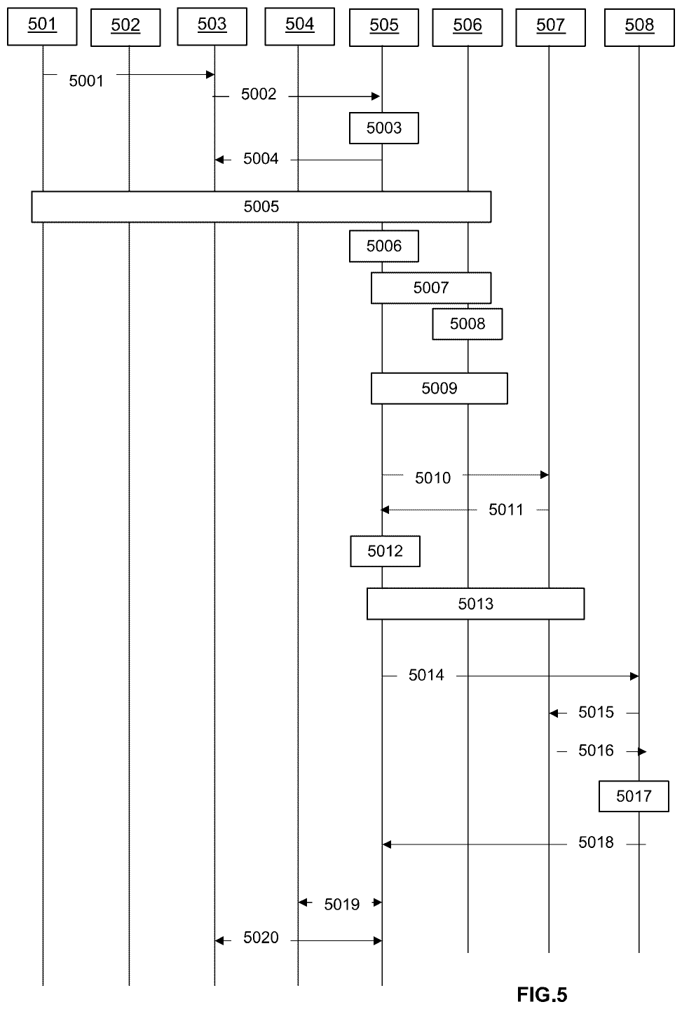

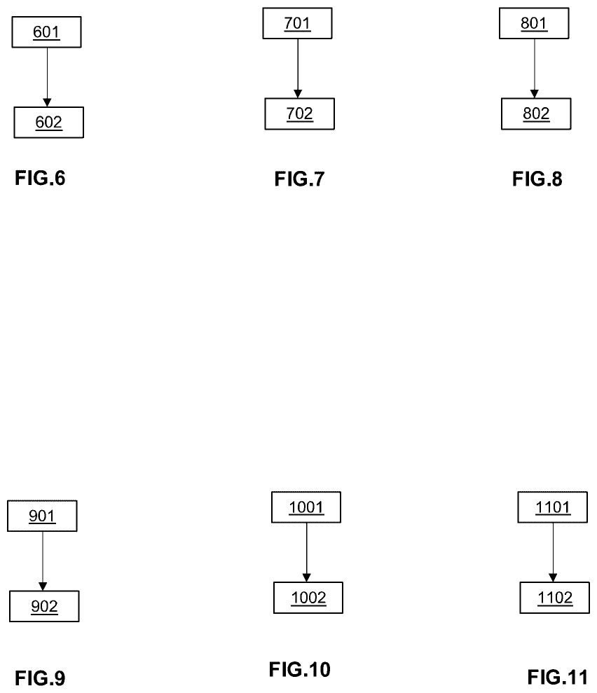

FIGS. 6 to 11 illustrate example operations that may be performed by apparatus.

### DETAILED DESCRIPTION

In the following description of examples, certain aspects are explained with reference to devices that are often capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems (for example, current 6G proposals, IEEE 802.11, etc.).

Before describing in detail the examples, certain general principles of a 5G wireless communication system are briefly explained with reference to FIGS. 1A to 1C.

FIG. 1A shows a schematic representation of a 5G system (5GS) 100 of a communication network. The 5GS 100 may comprise a user equipment (UE) 102 (which may also be referred to as a communication device or a terminal), an access network (AN) (which may be a 5G Radio Access Network (RAN) or any other type of AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes.

The 5GC 106 may comprise one or more Access and Mobility Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. The role of an NEF is to provide secure exposure of network services (e.g. voice, data connectivity, charging, subscriber data, and so forth) towards a 3rd party. Although NRF 128 is not depicted with its interfaces, it is understood that this is for clarity reasons and that NRF 128 may have a plurality of interfaces with other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The network may further comprise a management data analytics service (MDAS) producer or MDAS Management Service (MnS) producer. The MDAS MnS producer may provide data analytics in the management plane considering parameters including, for example, load level and/or resource utilization. For example, the MDAS MnS producer for a network function (NF) may collect the NF's load-related performance data, e.g., resource usage status of the NF. The analysis of the collected data may provide forecast of resource usage information in a predefined future time window. This analysis may also recommend appropriate actions e.g., scaling of resources, admission control, load balancing of traffic, and so forth.

Communication systems of mobile networks have charging and billing domains that are provided by a charging infrastructure. These charging and billing domains may use charging data records (CDRs) for charging and billing users of a communication system operated by a mobile network operator or subscribers of a mobile network operator. The charging infrastructure enables one or more of online and offline charging.

One example of a charging infrastructure is shown in FIG. 1B. This may be in the context of a 5G system (5GS). As illustrated in FIG. 1B, a billing domain 521 is connected via a Bx interface to a charging function (CHF) 523. The CHF may be part of a converged charging system (CCS) 525, where a converged charging system is a charging system that relates to both online and offline charging. The CHF 523 is connected via an Nchf interface to a charging enablement function (CEF) 527.

Management data analytics (MDA) 541 may be provided. The MDA 541 may comprise a management data analytics service (MDAS) producer 535 and one or more MDAS consumers such as MDAS consumer 537 and management service (MnS) consumer 539.

The MDA 541 may be connected to the CEF 527 via an MDAS interface 542.

The MDA 541 may be connected to MnS producer 529, a network data analytics function (NWDAF 533) via an Nnwdaf interface, and a further MDAS producer 543.

Management data analytics (MDA) may provide an insight that assists decision functions or services. MDA may provide one or more of the following:
(i) numeric results related to statistics or predictions, e.g., average values, cumulative distribution functions (CDF), etc.;
(ii) recommendation options, e.g., optimal target cell; and/or
(iii) root cause results.

MDA results may be provided for a specific time frame and for particular target objects, for example: a management object—distinguished name (DN); an area of interest (e.g., a geographical area); a user equipment (UE); a set of UEs; etc.

Several MDA use cases consume user and/or service-related analytics from the network data analytics function (NWDAF). This may introduce a form of indirect charging since the production of analytics activity of MDA and NWDAF are related.

Analytics may be provided by at least one of: MDA; NWDAF; a combination of MDA and NWDAF.

The terms management data analytics service (MDAS) and MDA MnS are generally equivalent and may be used interchangeably. Management data analytics service (MDAS) may comprise the services exposed by the MDA. MDAS can be consumed by various consumers, for example and without limitation: Management functions MnFs (i.e., MnS producers/consumers for network and service management), network functions NFs (e.g., NWDAF), SON (self-organising network) functions, network and service optimization tools/functions, SLS (service level specification) assurance functions, human operators, application functions (Afs), and/or the like.

Another example of a charging infrastructure is described in 3GPP TS 32.240, clause 4.3.3, which is illustrated with respect to FIG. 1C. This FIG. illustrates a converged charging system that comprises a CHF that interacts with an Account and balance management function (ABMF), a Charging gateway function (CGF), and a rating function (RF).

With the increasing concern about energy consumption and carbon footprint, mobile network operators are looking to optimize their communication systems and are looking for ways to save energy (e.g., reduce the energy consumed by their communication systems). For example, workloads of the communication system may be moved to be run at more energy efficient times and/or on more energy efficient computing systems. Individuals, organizations, and/or regulators may require awareness about carbon emissions related to the usage of communication systems of mobile network operators. This may be with the aim of improving low-carbon oriented metrics or energy usage of communication systems of mobile network operators.

5G communication systems, and upcoming 6G communication systems, are being increasingly designed to save energy (e.g., reduce their energy consumption) and increase their energy efficiency. However, one issue with the charging infrastructure shown in FIGS. 1B and 1C, is that energy information is not considered as a criterion to be measured, reported, and/or to be used to enforce policies (e.g., policy rules managed by a Policy Control Function). Further, it would be useful for an operator of a communication system to be able to perform differentiated charging taking into account the energy state of the communication system.

To address this, it has been previously proposed to enable mobile network operators to support differentiated charging based on a consideration of energy-related information. The energy-related information may be, for example, energy state of a communication system, energy dependent credits, and/or the like.

An energy dependent credit may be a quantity of credit associated with the subscriber that can be used for credit control by the 5G system.

In some examples, an energy dependent credit may be dependent on the energy related context. The energy related context may be an energy state, such as discussed in more detail below.

In some examples, there may be a relationship between energy credit and carbon emissions. Carbon emissions may be kilograms of equivalent carbon dioxide emitted (kg of CO2 equivalent).

In some examples, there may be a relationship between energy credit and carbon intensity. Carbon intensity may be quantity of CO2 equivalent emission per unit of final energy consumption for an operational period of use.

The energy-related information may be an energy state of one or more entities (e.g., RAN (radio access network), UPF (user plane function) of a communication system (of a mobile network operator) involved in processing user plane traffic of a data session for a user. The energy state associated with two or more entities involved may be provided separately or aggregated together and provided as an aggregated energy state.

In some examples, users may be charged differently when the communication system operated by a mobile network operator operates in an energy saving state where the communication system is reducing its capacity to save energy versus a normal energy state where the communication system is offering its full capacity.

Energy state may be the state of a cell, a network element and/or a network function with respect to energy. For example, an energy state may be an energy saving state or an energy normal state. An energy normal state is state in which a cell, network element, and/or a network function is not saving energy (e.g., operating normally with respect to energy).

In some examples, there may be a single energy saving state. In other examples there may be a plurality of different energy saving states associated with different energy usage values. In some examples, each respective energy saving state of the plurality of energy saving states may be associated with an energy usage value and each energy state value may be a different value.

In some examples, users (e.g., subscribers) may be charged differently when a communication device (e.g., a UE) of the user (e.g., subscriber) causes the communication system (e.g., an entity of the communication system) to change its energy state based on energy usage. For example, a communication device (e.g., a UE) of a user (e.g., a subscriber) may cause the RAN of the communication system to initiate a cell wake-up procedure. In this example, a user (e.g., a subscriber) may be charged an amount for waking up a cell which is greater than an amount that is charged for using a cell which is already active.

In some examples, users (e.g., subscribers) may be charged differently or provided with a reward for tolerating a lower quality of service (e.g., a low data rate or high latency). This tolerance for a lower quality of service may for example allow the communication system to remain in an energy saving state when a communication device (e.g., UE) of the user (e.g., subscriber) is using (e.g., communicating with) the communication system.

In some examples, subscribers may have a subscription with maximum limits in a defined time period. The defined time period may be for example, a month. The maximum limit may be associated with a measure of carbon emissions of the communication system permitted for the subscriber (generally referred to as carbon emission measure) or a value related to energy computation of the communication system when used by the subscriber (generally an energy consumption related value). The maximum limit may be a maximum value defined in terms of an energy quota. This maximum value may be defined in terms of an energy dependent credit quota.

In some examples, users (e.g., subscribers) may be informed about their individual energy consumption. For example, a user (e.g., subscriber) may be provided with information about their individual energy consumption. This information may be provided offline, for example in a monthly bill. The information may be provided as online information. For example, the user (e.g., subscriber) may be notified by a push message or on request. The information may be provided as an SMS (short message service) message or any other suitable message.

At some time of the day an operator may strive to switch off the “higher layer” of the RAN in some areas (e.g., to switch off cells related with higher frequencies that bring capacity but not coverage). Any user plane traffic that would require the RAN to switch on again a cell within this “higher layer” of the radio network induces a big energy cost.

In some examples, the energy state of one or more entities involved in processing UP (User Plane) traffic of a data session (e.g., a packet data unit (PDU) session) is provided as part of the charging data related with this UP traffic. The energy state of an entity involved in processing UP traffic may be for example, a normal energy state, an energy saving state, a sleep state, an exiting of a sleep state caused by the specific data session (e.g., PDU session) for the UE, and/or the like. The energy state information may be information indicative of a current energy state of an entity and/or information indicative of a change of energy state of an entity resulting from processing the user plane traffic of the UE of a subscriber. It should be appreciated that in some examples, an entity involved in processing UP traffic may have plurality of different energy states. Different ones of these energy saving states may represent different levels of energy saving by the entity.

For example, an energy state of one or more entities of a 5G AN (access network) serving a communication device of a user (e.g., subscriber) and/or an energy state of the UPF serving the data session (e.g., PDU session) may be provided.

In some examples, the energy state of two or more entities may be combined or aggregated to form a combined or aggregated energy state. The combined or aggregated energy state may be provided as a value representing the combined or aggregated energy state. For example, a lower energy state may have the value x and a higher energy state a value y. x and y are different. For example y may be higher than x. The energy state of two or more entities may be combined or aggregated in any suitable way form a combined or aggregated value.

In some examples, the 5G AN energy state value (e.g., the value of an energy state of a 5G AN) may be combined by the UPF with its own energy state value (e.g., with the value of its own energy state).

In some examples, the energy state value of one or more entities of a secondary AN having a different RAT (radio access technology) than a primary RAN used by the subscriber, if applicable, may alternatively or additionally be provided. A different entity may thus combine or aggregate the energy state values of the entities of the RAN with a different RAT and then the UPF.

In some examples, the energy state of an entity may contain information related to the cause or reason for this energy state and/or information about the last change of energy state. For example, the change to the energy state of a RAN may be due to a switch-off of a cell by the RAN, switch on of a cell by the RAN due to receipt of a wake-up signal from a communication device (e.g., UE) and/or the like. This may be used for example to charge a subscriber of a communication device (e.g., a UE) more if the subscriber is deemed accountable for the last energy state change of an entity (such as an entity of a 5G AN or an UPF) serving a data session of the user from an energy saving state to an energy normal state.

In some examples, the entities involved in processing UP traffic of a data session may include their energy state values as part of the charging data that they report to a CHF.

The energy state values may be used to determine energy dependent values. The energy dependent values may be energy dependent credit consumption values.

Energy dependent credit consumption information may be passed from the SMF (Session Management Function) and/or UPF to CHF in some examples,

Energy dependent credits may be a quantity of credit associated with a user (e.g., subscriber) that can be used for credit control by the charging infrastructure. This may be controlled by the communication system (e.g., 5G system). A user (e.g., subscriber) may be provided with one or more energy dependent credit quotas. There may be one energy dependent credit quota for each energy state of each entity so that a user (e.g., subscriber) may consume different independent energy dependent credit quotas depending on the energy state of the entities involved in processing user plane traffic of a data session for a user (e.g., a UE of a user (e.g., a subscriber)).

In some examples, energy dependent values may provide charging units related to energy. For example, energy dependent values can correspond to carbon emission units, energy consumption units, and/or the like.

Such energy dependent values may be determined from one or a combination of two or more measurable KPIs (key performance indicators). These measurable KPIs may comprise one or more of:
1) One or more KPIs provided by the mobile network operator and related to a user (e.g., subscriber). For example, the one or more KPIs may comprise one or more of data volume, QoS (quality of service), service identifier, access type, consumption pattern for example based on a location of a communication device of the user (e.g., subscriber), and/or the like. By way example, this may be much data is used for subscriber X in the a given entity for processing that subscriber's data. The entity may be for example an RAN or UPF entity.
2) One or more KPIs provided by the communication system operated by the mobile network operator and unrelated to a user (e.g., subscriber). For example, the one or more KPIs may comprise one or more of energy state, energy source, energy cost, and/or the like. Where two or more different energy sources are used, the KPI may be an indication of the ratio of the different energy sources or amount of each of the different energy sources. For example, this may be energy state of an entity. The entity may be for example an RAN or UPF entity.
3) One or more KPIs independent of the communication system operated by the mobile network operator. For example, the one or more KPIs may comprise one or more of time, day, season, weather, and/or the like. For example, this may be the time that the entity was used. The entity may be for example an RAN or UPF entity.

The KPIs may be related to entities and their usage for processing the subscriber's traffic. The CHF may run an energy credit conversion algorithm or ask the SMF and/or UPF to run an energy credit conversion algorithm using one or more of the required KPIs.

Energy-related information may impact energy dependent credit consumption. For example, energy dependent credits may be consumed at a different rate depending on the energy state of the entities involved in processing user plane traffic of data session for a user (e.g., a user equipment of a user (e.g., subscriber)). In some examples, energy dependent credits when energy state is a normal energy state may be consumed independently from energy dependent credit consumption when the network is in an energy saving state.

In some examples, the CHF may allocate energy dependent credit. The CHF may provide downstream NF(s) with a quota. The quota may be associated with an identifier of a quota consumption rule (generally referred to herein as a quota consumption rule ID). The CHF may request to be notified when the quota is consumed. The downstream NF may be a SMF or a UPF (in that case the SMF may relay to the UPF the quota and the quota consumption rule ID).

In some examples, the CHF may provide two or more quotas. Different quotas may be provided for different energy states of the one or more entities involved in processing.

The energy dependent credit conversion algorithm (i.e., calculation or determination method) used to calculate or determine energy dependent credits may also depend on additional information. For example, the determination may depend on one or more of the service identifier, the slice type, the identifier, and/or the like.

In some examples, the energy dependent credit conversion algorithm may be based on an energy charging rate. The energy charging rate may be a rate at which energy dependent credits are consumed, based on any of the aforementioned energy information. In some examples there may be a linear relationship to a quantity such as, for example, data usage in the energy charging rate. For example, the energy charging rate may equal 10 energy dependent credit per GB (gigabyte) consumed.

The energy dependent credit conversion algorithm may be provided in any one or more of the entities involved in processing user plane (UP) traffic of a data session for a user (e.g., a UE of a user (e.g., subscriber)).

In such a system that provides differentiated charging based on energy considerations, information on the energy state and/or the energy dependent credits for a particular user may be provided to the CHF from another network function (e.g., a session management function (SMF) and/or access and mobility management function (AMF)), and from the CHF to other network functions (e.g., a policy control function).

For example, such energy state and/or energy dependent credits information may be provided to the CHF from an AMF for registration charging (e.g., charging for a user equipment (UE) registration) in charging data messages sent to the CHF. For example, there may be admission control related to an energy dependent credit level. For example if all energy dependent credits are consumed, the UE registration may be rejected.

As another example, such energy state and/or energy dependent credits information may be provided to the CHF from the SMF as part of charging information provided to the CHF for generating charging in respect of a session associated with a UE. In more detail, the SMF may instruct a user plane function (UPF) to report a UE's energy dependent credit usage. The SMF may instruct the UPF to report the energy dependent credit conversion algorithm supported by the UPF. The CHF 523 may be configured to receive the energy-related information from the SMF. The energy information may be received in a response to a charging data request. The CHF 523 may be configured to create or generate CDRs based on the received energy information. The CDRs will differentiate the data usage and/or policy counters during a normal state versus an energy savings state. The CDRs may be used for billing by charging subscribers differently for energy savings state as compared to the normal state and/or the like.

As mentioned above, the CHF may provide the energy dependent credit quotas and the like to other network entities. For example, the CHF 523 may provide energy dependent credit quotas and usage in charging data responses sent to other NFs. The charging data responses sent to other NF may alternatively or additionally report the energy dependent credit conversion algorithm to be used.

For example, a policy control function (PCF) may be configured to get information from the CHF 523 about when a subscriber of a UE (or a group the subscriber of a UE belongs to) has consumed its energy dependent credits quota or when a new or updated quota has been granted. The PCF may take this information into account to change the QoS authorized for data sessions (e.g., PDU sessions) of the UE of the subscriber.

The above-described systems that apply differentiated treatment to a UE based on how energy efficiently that UE is behaving can be relatively complex. This is especially the case when there are a large range of parameters that both directly and indirectly impact how energy efficiently that UE is performing, as it can be difficult for algorithms to accurately and consistently evaluate a UE's behaviour. Moreover, it is possible that the energy credits and/or energy usage associated with a UE may be calculated incorrectly, either as a result of a malfunctioning network function (e.g., a malfunctioning user plane function) and/or as a result of a network function not having access to all available information about the operations of a UE.

The following aims to address at least one of the above-mentioned issues.

In particular, the following proposes a functionality for a network analytics function to evaluate a UE's behaviour and categorise the UE into one energy behaviour category of a discrete number of existing energy behaviour categories defined by a network operator. The number of energy behaviour categories may be two (e.g., “green” or “not green”), or more than two (e.g., “Category A”, “Category B”, “Category C” etc.). Each of these energy behaviour categories may be associated with a respective set of policies of a communication network that may be applied in respect of the UE's usage of the communication network. For example, energy behaviour categories associated with a higher energy efficiency behaviour of the UE may be associated with better quality of service, less expensive charging, etc., relative to energy behaviour categories associated with a lower energy efficiency behaviour of the UE.

An indication of which energy behaviour category has been assigned to a specific UE can be provided to various other network functions for, for example, applying differentiated charging and/or for adjusting policies for that UE based on the assigned energy behaviour category.

The network analytics may be arranged to continuously monitor the UE's behaviour to determine whether the UE should be assigned to (or otherwise mapped to) another energy behaviour category. The network analytics may be arranged to periodically and/or aperiodically monitor the UE's behaviour to determine whether the UE should be assigned to (or otherwise mapped to) another energy behaviour category.

When the network analytics function determines that a UE should be assigned to a different energy behaviour category to the energy behaviour category currently assigned to that UE (e.g., as a result of the network analytics function determining that the behaviour of the UE has changed to such an extent that the UE should be placed in the different energy behaviour category), the network analytics function may provide an indication of the new/different energy behaviour category to at least one other network function (e.g., a charging function, a session management function, and/or a policy control function) for that at least one other network function to determine whether a policy associated with that UE should change based on the change in energy behaviour category.

For example, a charging function may apply different charging mechanisms based on the change in energy behaviour category (such as different energy credit schemes, as discussed above).

As another example, a policy control function may cause a different quality of service to be applied in respect of the UE's communications based on the change in energy behaviour category (e.g., an improvement in quality of service may be correlated with a UE behaving in a more energy efficient way).

As another example, when a UE's user energy behaviour category indicates that the UE has recently had a very “green” friendly behaviour, the PCF may adjust at least one policy associated with the UE to reward/provide the UE with a higher aggregated maximum bit rate and/or with some priority access to a frequency layer that allows a higher data throughput.

In more detail, a network analytics function may assign a UE to an energy category (also called a “user energy behaviour category” herein) that is defined by at least one network operator. Each of these energy behaviour categories may be associated with a respective set of policies. Each set of policies may comprise more than one policy. For example, each set of policies may comprise at least one charging policy, at least one quality of service (QOS) policy, etc. Each policy may be associated with at least one element of user equipment behaviour such as, for example, most frequent time of UE usage, most frequency are in which UE is used, etc.

The assigning network analytics function may provide an indication of which user energy behaviour category has been assigned to a specific UE to at least one other network function and/or to the specific UE. The at least on other network function may be able to correlate that user energy behaviour category to at least one policy in the set of policies associated with that user energy behaviour category, and cause that at least one policy to be applied.

For example, when the other network function is a PCF, the PCF may receive the indication of the UE's assigned user energy behaviour category, and cause a property (e.g., a quality of service) of the UE's communication sessions to be changed in dependence on the set of policies associated with that assigned user energy behaviour category. In such a way, the UEs communications may be provided with a better quality of service when the UE is determined to be operating in a relatively energy efficient manner compared to the quality of service received when the UE is determined to be operating in a less energy efficient manner.

As another example, when the other network function is a CHF, the CHF may apply differentiated charging policies depending on which user energy behaviour category a specific UE is assigned to. Stated differently, the CHF may apply the energy credit behaviour discussed above based on the provided user energy behaviour category.

As mentioned above, information on which user energy behaviour category has been assigned to a UE may also be provided to that UE. The UE may provide this information to a user of the UE. The user of the UE may change their usage of the UE in dependence on this information. For example, the pattern of input received from the user at the UE after the energy behaviour category has been provided to the user may vary to the pattern of input received from the user at the UE before the energy behaviour category was provided to the user.

Stated differently, the following also recognises that users may be motivated to change their behaviour regarding energy usage associated with how they use their UE when provided with information regarding how that may be done. The following proposes mechanisms for saving energy in a network by encouraging users to change their behaviour to use their UE in more energy efficient ways. This may result in a network being able to operate more energy efficiently (e.g., by turning off non-utilized resources). In response to a user being provided with information regarding the energy efficiency of how they use their UE, the user may change their usage of the UE such that the UE receives user input according to a different usage pattern than prior to the user being provided with that information.

In addition to a user being generally inclined to change their usage pattern, the user may be offered various inducements to change their behaviour. For example, a user may be charged less if they use their device in a more energy efficient way. This can be achieved by, for example, adopting an appropriate dynamic charging policy, applying different Rating Groups (see below) and Quota Management (where Quota management is done per Rating Group (RG) per PDU session). Historical charging data either of a Subscriber or UE may be taken into account when determining what inducement to offer. In this way, incentives are provided to users for supporting a network operator's efforts in saving energy.

Information regarding a UE's energy efficiency category may be usefully deployed in a factory-type setting (and/or in some setting in which a plurality of UEs provide machine-to-machine communications to a centralised controller, such as in smart meter deployments).

For example, in a factory deployment, an application may receive and use indications from the network layer regarding the energy efficiency categories of UEs registered to the application function to detect that one of the UEs (e.g. a robot) is mis-configured as it exhibits a less energy friendly behaviour relative to other UEs that perform similar functionality to that UE. For example, it may be determined that a robot is consuming too many network resources during the night while the network is in energy saving mode and the robot should be idle. In this case, the application function may cause the robot to be reconfigured to perform in a more energy efficient way.

These concepts are illustrated more in the following examples.

As a precursor to the following examples, examples of user energy behaviour categories defined by a network operator and how they may be mapped by an analytics function are first discussed.

As mentioned above, at least one UE may be assigned (e.g., mapped) to an energy behaviour category of a plurality of energy behaviour categories defined by a network operator. An analytics function may map UE to an energy behaviour category based on the UE's energy usage behaviour (e.g., utilized energy credit units). It is understood that there may be occasions during which an energy behaviour category is not assigned to any UE.

In this example, category A may be considered as a “best” service usage behaviour from an energy perspective, and correspond to an operation that is most aligned with the operator's energy saving strategy (e.g., to UE usage patterns in which users consume fewer energy credits relative to other UE usage patterns).

Some examples of the ways in which a UE usage pattern may change comprise: a UE changing (e.g., using) a time (also referred to herein as a “proper time” during which the UE consumes energy consuming services from the network (e.g., performs big downloads during times when the network is expected to have a relatively low load, such as night time, etc.), a UE changing (e.g., limiting) its background data by enabling Data Saver Mode, a UE changing (e.g., using) 5G QoS identifiers (5QIs) (or similar 6G QoS identifier values) that allow a more energy saving network operation.

Further in this example, UEs assigned to category B have a worse behaviour from an energy perspective than UE assigned to category A, but have a better behaviour from an energy perspective than UE assigned to category C, etc. Finally, UE assigned to category F are considered to have the worst behaviour from an energy perspective. UE assigned to category F may be considered to have behaviour that does not give any possibility (or any noticeable possibility) to the operator to save energy.

Some examples of user energy behaviour categories are provided below, with illustration to an example deployment.

User energy behaviour categories can be labelled using two or more categories as discussed above (e.g. category A, category B, . . . category F, etc.), or labelled using either “green” or “not-green”, where “green” indicates more energy efficient behaviour than “not-green”.

User energy behaviour categories can be derived from clustering techniques, which may not have explicit labels that can be easily compared, as they may be identified out of multiple parameters. However, such categories may still be compared with each other and provide some indication on the reason why a UE was considered as part of this cluster/category. For example, a network analytics function may evaluate the operation of a plurality of UE and map each UE of the plurality of UEs into an energy behaviour category based on their behaviour relative to each other. This may be further refined by the network analytics function grouping the plurality of UE into different types based on at least one property of the UE (e.g., an operating system), and performing respective comparisons across UE within each group.

Further, user energy behaviour categories can be defined by the operator differently for different groups of users. For example, category A, category B, . . . category F may be used by an operator for categorizing users in an enhanced Mobile Broadband (eMBB) UEs, while the binary “Green” and “Not Green” categorization may be used by the operator for UEs of a specific Campus network and/or an Internet of Things (IoT) network.

The categorization of each of the plurality of user behaviour energy categories may be performed by a network operator, and the assigning energy behaviour of a UE to a user behaviour energy category may be performed by a specific network function (such as, for example, a network data analytics function (NWDAF) and/or a Charging Function, CHF). The operations of such a network function is considered in more detail below. For clarity and brevity, the present examples consider the assigning/mapping of energy behaviour categories as being performed by an NWDAF. However, it is understood that other network functions may perform the features mentioned below.

In this example, an NWDAF receives a request to perform a determination of a UE's user energy behaviour category from at least one source 5GC NF(s). The NWDAF may determine the user energy behaviour category as a new type of UE-related analytics based on information comprised in this received request and/or other inputs obtained by the NWDAF. The user energy behaviour category may be one of a plurality of different user energy behaviour categories defined by a network operator.

The request may specify at least one parameter for the analytics request.

For example, the request may identify the UE(s) whose behaviour is to be identified. For example, the request may comprise an identifier of the UE that is the subject of the request (or an identifier of more than one UE that is the subject request).

The request may specify time-related parameters. For example, the request may comprise an indication of a duration over which the analytics is to be performed, and/or comprise an indication of a future time period to which the user energy behaviour is to apply.

The request may provide parameters indicating how the analytics is to be performed. For example, the request may provide an indication of a granularity of the analytics being performed.

The request may indicate a form in which the analytics result is to be returned to the requestor. For example, the request may comprise an indication of whether context is to be provided to the result (e.g., an indication of how a UE may improve its user energy behaviour category).

The request may comprise an identifier (e.g., an analytics identifier) for identifying and associating together the analytics request with the returned analytics results.

As an example to illustrate the above, an analytics request provided to the NWDAF may comprise at least one of the following:
Analytics ID=“User energy behaviour”.
Target of Analytics Reporting: a single UE (e.g., SUPI) or a group of UEs (e.g. an Internal Group ID).
Analytics Filter Information, for example:
Single-Network Slice Selection Assistance Information (NSSAI);
Data Network Name (DNN); and/or
An identifier of an application;
An Analytics target period that indicates a time period over which the statistics or predictions are requested.
A requested granularity of the analytics, e.g., energy behaviour category per hour, per day, or for the total analytics target period.
A preferred level of accuracy of the analytics.
A preferred level of accuracy per analytics subset;
A spatial granularity size (e.g., if an Area of Interest is provided); and
When the request relates to a subscription, a Notification Correlation Id and a Notification Target Address.

In order for the NWDAF to generate analytics related to the above-mentioned request the NWDAF may obtain information from at least one other source (e.g., by signalling a request to the at least one other source for input information). For example, 3GPP TS 23.288 V18.2.0 (2023-06) indicates at least one function that generates (e.g., another NWDAF instance) and/or stores (e.g., an Analytics Data Repository Function (ADRF)) at least one of the above-mentioned input values. The obtained input information may, for example, comprise at least one of UE communication analytics, UE mobility analytics, etc.

In addition to the above-mentioned obtained information, the NWDAF may obtain 5GS energy-saving planning and consume Charging Data Records (CDRs) from the Charging Function (CHF) with energy-related information such as the energy credit consumption by the UE/subscriber per network energy-state. This may be as described above in relation to energy credit consumption. Detailed information that may be collected by the NWDAF includes parameters mentioned below in Table 1.

TABLE 1
Service Data available from 5GC related to user energy behaviour

| Information | Source | Description |
|---|---|---|
| UE | NWDAF | Data analytics on UE communication pattern |
| communication | | and user plane traffic as specified in clause |
| analytics | | 6.7.3 of TS 23.288. |
| UE mobility | NWDAF | Data analytics providing UE mobility |
| analytics | | statistics or predictions as specified in clause |
| | | 6.7.2 of TS 23.288. |
| CDR | CHF | CDRs comprise energy-related information |
| | | such as network energy state when the CDR |
| | | was created, energy credits per network |
| | | energy state, etc. |
| 5GS Energy- | RAN | RAN can send the energy-saving plan to 5GC |
| saving plan | | |

NOTE:
NWDAF can directly retrieve UE communication analytics and/or UE mobility analytics (e.g. from another NWDAF or from a repository such as ADRF) or it can itself collect (some/all) input parameters as listed in tables Table 1 and/or Table 2

As stated in TS 29517 V18.2.0 (2023-06), an AF provide may provide service or application related information to NF service consumers. Information related to UE energy consumption from this service and/or application related information may be provided as an input by NWDAF for assisting the NWDAF in mapping a UE to an energy behaviour category. Example information that may be used by the NWDAF is illustrated below in Table 2.

TABLE 2
Service Data from AF related to user energy behaviour

| Information | Description |
|---|---|
| UE ID | Could be external UE ID (e.g., Global permanent |
| | subscriber identifier (GPSI)) |
| Application ID | Identifies the application providing this information |
| UE energy | Timestamped and geolocated energy consumption |
| information | information associated with this application |
| (1..max) | |
| >Application | Indication of energy used by the AF to |
| energy | provide the application |
| >UE location | Geographical area that the UE enters |
| >Timestamp | A time stamp when UE enters this area |

NOTE:
When an application ID is not provided by the AF, the collected UE energyinformation may be applicable to all the applications for the UE.

Depending on a requested level of accuracy, data collection may also be performed on data samples associated with the UE(s) being analyzed in order to collect information to be used as part of the analytics request (e.g., spatial subsets of UEs or UE group, temporal subsets of information).

After receiving at least one of the above-mentioned input(s), the NWDAF may perform data analytics on current and past energy consumption of a UE to identify any energy consumption pattern(s). The NWDAF may provide analytics result(s) that indicates user energy behaviour category statistics and/or prediction to other NFs in the 5GC and/or to an AF.

The user energy behaviour categorization algorithm used by the NWDAF to assign a UE to one of a predetermined set (e.g., more than one) of user energy behaviour categories may be applied to all UEs of a single administrative domain (e.g., of a single Public Land Mobile Network (PLMN)).

The user energy behaviour categorization algorithm used by the NWDAF to determine a user energy behaviour category may be differentiated according to, for example, a slice and/or a non-public network (NPN). For example, UEs operating within a specific NPN in an industrial campus may be mapped according to a different mapping algorithm with respect to their energy behaviour than consumers served by a PLMN of the same operator. Stated differently, UEs of a first type (e.g., UEs being served by a first non-public network) may be mapped into a different energy behaviour category relative to UEs of a second type (e.g., UEs being served by a public network) even when the behaviour of those UEs are otherwise identical.

Some categorization algorithms may allow to compare user energy behaviour categories across different operators.

This may be useful when considering how information is used by a 3rd party application function. For example, such an application function would need to be able to compare the category assigned for a first UE by a first network operator against the category assigned for a second UE by a second network operator. Further, different network operators may agree on a common set of categories in order to align behaviour. For similar reasons, an “energy usage label” might be introduced that may render user categorization comparable across different network operators.

Two simple categorization algorithms are shown below in Tables 3 and 4 to illustrate examples of how user equipment may be categorized.

TABLE 3
First example user energy behaviour categories

| INPUT (eg from UE | |
|---|---|
| communication analytics or | |
| energy-based charging) | OUTPUT |
| Max consumption % (eg data | User energy |
| volume, energy credit) during | behaviour |
| energy saving state | Category |
| 100 | A |
| 60 | B |
| 40 | C |

TABLE 4
Second example user energy behaviour categories

| | | OUTPUT |
|---|---|---|
| INPUT (eg from | | User energy |
| mobility analytics) | | behaviour |
| Location | Time | Category |
| TAI 1 | 8:00-19:59 | Green |
| TAI 1 | 20:00-7:59 | Not-Green |
| TAI 2 | 0:00-23:59 | Green |
| TAI 3 | 0:00-23:59 | Not-Green |

This second example assumes that TAI 1 is a location that is largely powered by a solar plant, whilst TAI 2 is a location that is largely powered by a geothermal plant, and TAI 3 is a location that is largely powered via an energy grid associated with a “non-green” contract.

The analytics results provided by the NWDAF may comprise user energy behaviour predictions. These may be as illustrated below in relation to Table 5.

TABLE 5
User energy behaviour Predictions

| Information | Description |
|---|---|
| UE group ID or | Identifies a UE or a group of UEs, |
| UE ID | e.g. internal group ID defined in clause 5.9.7 |
| | of TS 23.501 or SUPI (see NOTE). |
| User energy behaviour | User energy behaviour category Predictions |
| predictions (1..max) | (e.g., category A, category B, etc.) |
| >Confidence | Confidence of the prediction. |

The analytics results provided by the NWDAF to the requestor in response to the request may comprise user energy behaviour statistics. These results may comprise the information illustrated below in relation to Table 6.

TABLE 6
User energy behaviour Statistics

| Information | |
|---|---|
| Provided by | |
| NWDAF | Description |
| UE group ID | Identifies a UE or a group of UEs (e.g. internal group ID |
| or UE ID | defined in clause 5.9.7 of TS 23.501 or subscription |
| | permanent identifier (SUPI)). |
| User energy | User energy behaviour information based on statistics |
| behaviour | (e.g., based on historical behaviour). |
| (1..max) | The user energy behaviour information may be a single |
| | user energy behaviour category of a defined user energy |
| | behaviour categories, or may comprise information |
| | allowing the NWDAF service consumer (e.g., the sender |
| | of the request) to map the UE to one of the energy |
| | behaviour categories. |
| | Depending on the requested granularity of the analytics, |
| | the information may be provided as a single user energy |
| | behaviour category (low level of granularity), or a set of |
| | (more than one) user energy behaviour categories for |
| | different time periods (high level of granularity). |
| >Time period | Indicates the time period to which the user |
| | energy behaviour category applies. |

In addition to providing a user energy behaviour, the output from the NWDAF may optionally comprise a recommendation of the same or another user energy behaviour category that the 5GS will use to suggest as an objective to the UE. The output of any of the user energy behaviour categories may be provided in the form of a set of values of a plurality of parameter of a UEs behaviour, and/or in the form of a single identifier of a category that is associated with a set of values of a plurality of parameter of a UEs behaviour.

The output may optionally comprise some indication, based on the collected input data related to why the UE is categorized into the returned user energy behaviour category. This may be useful for indicating a primary operational area that may be modified by the user and/or UE for complying with a more energy efficient operation.

The output may optionally comprise some indication, based on the collected input data, that comprises information relating to how a UE and/or user may change the UE's transmission and/or reception behaviour to conform with a recommended user energy behaviour category and/or with a more energy efficient user energy behaviour category that the one currently associated with the user.

Once determined for at least one UE, the user energy behaviour category may be used by at least one 5GC NF to apply differentiated policies depending on the determined user energy behaviour.

For example, the user energy behaviour category may be used to determine a “rating group” that influences the charging of the UE's traffic. This is discussed further below.

As another example, the user energy behaviour category of a UE may be used to determine at least one Quality of Service (QOS) policies for traffic exchanged by the UE.

As another example, the user energy behaviour category for a UE may be used to prioritize the UE when selecting very local user plane functions (UPFs), which may be scarce resources.

The user energy behaviour category may be used by a PCF, and/or by an SMF, and/or by a CHF. At least some of these are illustrated further below in relation to FIGS. 4 and 5, which respectively relate to a PCF-based approach and to an SMF-based approach.

The PCF- and SMF-based approaches may comprise the PCF/SMF contacting the NWDAF to get the user energy behaviour category and then using the information as input to their local policies.

The Rating Group (also called Charging Key) may be determined by a PCF that provides the Charging key to the SMF as part of Policy and Charging Control (PCC) rules for a session. These are currently defined in 3GPP TS 23.503, Table 6.3.1-1.

The PCF may obtain the user energy behaviour category from the NWDAF as discussed above (e.g., by sending a request for this information to the NWDAF), and/or from a charging function (e.g., using a dedicated charging counter state of an interface between the SMF and PCF). For example, the CHF may store policy counter information and compare it with the subscriber's charging plan and notify PCF in case that the subscriber charging counter state breaches the policy thresholds.

Following receipt of the user energy behaviour category for a particular user, the PCF may cause at least one policy to be changed for that user. For example, local policies in the PCF that are used to control the determination of the Charging Key(s) sent to the SMF may be determined in dependence on the user energy behaviour category. As another example, the PCF may cause an average bit rate to be changed for the UE, for the type of resources available to a UE to change, etc., as described above.

The RG may be updated dynamically when a new value of the user energy behaviour category has been received by the PCF (whether from the NWDAF and/or from the CHF).

In one example, there may be a 1-to-1 mapping between Rating Group (RG) and user energy behaviour category. Stated differently, different RG and charging rate combinations are associated with respective user energy behaviour categories. Other examples consider the user energy behaviour category as one of the parameters to define a Rating Group.

A respective charging policy is associated with each RG. For example, there may be provided a first rating group, RG1, that is associated on energy behaviour category A, with charging rate of x/hour or x/Gb, and a second rating group, RG2, that is associated with an energy behaviour category B, with charging rate of y/hour or y/Gb. In this example, worse energy behaviour categories will have a higher charging rate (e.g., where charging rate of category C>category B>category A).

Each RG may comprise UEs with similar energy behaviour. For example, one RG may correspond to UE that only (or predominantly) use the network over the weekends.

As mentioned above, the PCF may obtain the user energy behaviour category associated with a UE from a CHF (e.g., over an N28 and/or Nchf interface) or from the NWDAF). The PCF may use this information to determine policies for a PDU Session of this UE. The same may apply to the PCF of the AMF when, for example, determining the RFSP.

FIG. 4 illustrates example signalling that may be performed between a UE 401, an access network node 402, an AMF 403, a UPF 404, an SMF 405, a PCF 406, an NWDAF 407, and a CHF 408.

4001 to 4006 relate to signalling associated with stating a packet data unit (PDU) session, such as described in relation to FIG. 5.2.2.2.1 of 3GPP TS 32.255 and in relation to FIG. 4.3.2.2.1-1 of 3GPP TS 23.502.

During 4001, the UE 401 signals a PDU session establishment request to the AMF 43.

During 4002, the AMF 403 signals a session management request with a PDU session establishment request to the SMF 405.

During 4003, the SMF obtains subscription data for the UE 401 from a UDM (not shown).

During 4004, the SMF 405 signals a session management request with a PDU session establishment response to the AMF 403. In the present case, this signalling indicates that a session has been established in accordance with the request of 4002.

During 4005, PDU session authentication and/or authorization is performed.

During 4006, the SMF performs a PCF selection for determining policy information in relation to the session being established. In the present example, PCF 406 is selected during 4006.

During 4007, the SMF 405 signals the PCF 406. This signalling may be for establishing a policy association with the PCF in respect of the session being established. The signalling may comprise an Npcf_SMPolicyControl_Create Request signaling operation.

During 4008, the PCF 406 may determine whether a user energy behaviour category can be used for the UE 401. This may comprise, for example, a subscriber category (e.g., whether the UE is associated with a subscription for allowing the user energy behaviour category differentiation to be applied), a target DNN, and/or slice information.

During 4009, following a determination in 4008 that a user energy behaviour category can be used, the PCF 406 signals the NWDAF 407. This signalling may comprise a request for a user energy behaviour category in respect of the UE 401.

During 4010, the NWDAF 407 signals the PCF 406. This signalling may comprise at least one user energy behaviour category associated with the UE 401.

As mentioned above, it is understood that instead of signalling the NWDAF for the UE energy category information in 4009 and 4010. The PCF 406 may instead obtain this information from a charging function. This is illustrated with respect to 4011 and 4012.

During 4011, following a determination in 4008 that a user energy behaviour category can be used, the PCF 406 signals the CHF 408. This signalling may comprise a request for a user energy behaviour category in respect of the UE 401.

During 4012, the CHF 408 signals the PCF 406. This signalling may comprise at least one user energy behaviour category associated with the UE 401.

During 4013, the PCF 406 determines at least one policy for the UE 401 (e.g., for the established PDU session) using the user energy behaviour category received from the NWDAF 407 and/or the CHF 408.

During 4014, the PCF 406 signals the SMF 405. This signalling may comprise the at least one policy determined during 4013 that is based, at least in part, on the user energy behaviour category. This signalling may comprise an indication of the user energy behaviour category received from the NWDAF 407 and/or the PCF 408.

During 4015, the SMF 405 selects a UPF (e.g., UPF 404) for the UE 401 using the user energy behaviour category received during 4014.

During 4016, the SMF 405 performs session management policy modification using the user energy behaviour category receiving during 4014.

During 4017, the SMF 405 signals the CHF 408. This signalling may comprise a charging data request. This signalling may comprise an indication of the user energy behaviour category received during 4014.

When the signalling of 4017 does not comprise an indication of the user energy behaviour category, the CHF 408 may retrieve the user energy behaviour category for the UE 401 from the NWDAF, as shown in 4018 and 4019. The user energy behaviour category for UE 401 is requested during 4018, and provided to the CHF during 4019.

During 4020, the CHF 408 opens a charging record (CDR). This charging record may use the user energy behaviour category to determine a rating group for the UE 401.

During 4021, the CHF 408 signals the SMF 405. This signalling may comprise a charging data response. This signalling may comprise the RG determined during 4020.

Session establishment (and subsequent signalling) may then be performed. This is illustrated through the signalling of 4022 (in which the SMF 405 and the UPF 404 exchange session establish and/or modification signalling), and 4023 (in which the SMF 405 and the AMF 406 interact).

When the user energy behaviour category changes, the PCF may update the SMF with the new user energy behaviour category value. The SMF can then update the CHF with the new user energy behaviour category value. The PCF may obtain information regarding the changed user energy behaviour category value by either polling the NWDAF (or the CHF), or by subscribing to receive an indication of changes to this value.

FIG. 5 illustrates further example signalling. This signalling differs from the example of FIG. 5 in that, in FIG. 5, the PCF does not take user energy behaviour into account for its policy decision, and that the PCF may request that the SMF retrieves the user energy behaviour category from the NWDAF.

FIG. 5 illustrates example signalling that may be performed between a UE 501, an access network node 502, an AMF 503, a UPF 504, an SMF 505, a PCF 506, an NWDAF 507, and a CHF 508.

5001 to 5006 relate to signalling associated with stating a PDU session, such as described in relation to FIG. 5.2.2.2.1 of 3GPP TS 32.255 and in relation to FIG. 5.3.2.2.1-1 of 3GPP TS 23.502.

During 5001, the UE 501 signals a PDU session establishment request to the AMF 53.

During 5002, the AMF 503 signals a session management request with a PDU session establishment request to the SMF 505.

During 5003, the SMF obtains subscription data for the UE 501 from a UDM (not shown).

During 5004, the SMF 505 signals a session management request with a PDU session establishment response to the AMF 503. In the present case, this signalling indicates that a session has been established in accordance with the request of 5002.

During 5005, PDU session authentication and/or authorization is performed.

During 5006, the SMF performs a PCF selection for determining policy information in relation to the session being established. In the present example, PCF 506 is selected during 5006.

During 5007, the SMF 505 signals the PCF 506. This signalling may be for establishing a policy association with the PCF in respect of the session being established. The signalling may comprise an Npcf_SMPolicyControl_Create Request signaling operation.

During 5008, the PCF 506 may determine whether a user energy behaviour category can be used for the subscriber associated with the UE 501. This may comprise, for example, a subscriber category, a target DNN, and/or slice information.

During 5009, the PCF 506 signals the SMF 505. This signalling may comprise a request indicating that the SMF 505 is to retrieve at least one user energy behaviour category associated with the UE 501. This signalling may comprise at least one policy for the UE. This signalling may comprise an Npcf-SMPolicyControl_Create response message.

During 5010, the SMF 505 signals the NWDAF 507. This signalling may comprise a request for at least one user energy behaviour category in respect of the subscriber of the UE 501.

During 5011, the NWDAF 507 signals the SMF 505. This signalling may comprise at least one user energy behaviour category requested during 5010.

During 5012 the SMF 505 selects a UPF (e.g., UPF 504) for the UE 501 using the user energy behaviour category received during 5011.

During 5013, the SMF 505 performs session management policy modification using the user energy behaviour category receiving during 5011.

During 5014, the SMF 505 signals the CHF 508. This signalling may comprise a charging data request. This signalling may comprise an indication of the user energy behaviour category received during 5011.

When the signalling of 5014 does not comprise an indication of the user energy behaviour category, the CHF 508 may retrieve the user energy behaviour category for the UE 501 from the NWDAF, as shown in 5015 and 5016. The user energy behaviour category for UE 501 is requested during 5015, and provided to the CHF during 5016.

During 5017, the CHF 508 opens a charging record (CDR). This charging record may use the user energy behaviour category to determine a rating group for the UE 501.

During 5018, the CHF 508 signals the SMF 505. This signalling may comprise a charging data response. This signalling may comprise the RG determined during 5017.

Session establishment (and subsequent signalling) may then be performed. This is illustrated through the signalling of 5019 (in which the SMF 505 and the UPF 504 exchange session establish and/or modification signalling), and 5020 (in which the SMF 505 and the AMF 506 interact).

In this example of FIG. 5, the following proposes adding new information elements in the PCC rules sent by the PCF to the SMF during 5009. This new information may be in addition to the information signalled between a PCF and SMF in relation to an SM policy creation request (as shown in 3GPP TS 23.503, table 6.3.1). This new information is illustrated below in relation to Table 7.

TABLE 7
Additional PCF signalling to the SMF

| | | PCF permitted |
|---|---|---|
| | | to modify for a |
| Information | | dynamic PCC |
| name | Description | rule in the SMF |
| Charging | This part defines identities and instructions for | |
| | charging and accounting that is required for an | |
| | access point where flow based charging is | |
| | configured | |
| . . . | . . . | . . . |
| User energy | Indicates the user energy behaviour category. | Yes |
| behaviour | | |
| category | | |
| User energy | Indicates whether the user energy behaviour | Yes |
| behaviour | category shall be retrieved by the SMF. | |
| category | | |
| support | | |

In each of the examples of FIGS. 4 and 5, the UE energy category information signalled from the SMF to the CHF may be signalled using an additional information element in the charging data request message currently described in TS 32.254, table 6.2a.1.2.1.1

In each of the examples of FIGS. 4 and 5, the Charging Data Response returned by the CHF to the SMF may comprise an RG to be applied to the PDU Session, based on the provided user energy behaviour category. The CHF may determine the RG using any mechanism, including as discussed above (e.g., based on a mapping (e.g., a 1-to-1 mapping) between RG and user energy behaviour categories).

The SMF providing the CHF with the user energy behaviour category for a UE avoids the CHF having to request and/or subscribe to each user energy behaviour category in the system, which may be useful for scalability.

The charging method may be defined by a PCC rule, as per 3GPP TS 23.503. The charging method may comprise converged charging, which is charging that may comprise both online and offline charging. Converged charging can be based on the data volume either sent or received by the UE (it can be identified per subscriber and PDU Session).

The SMF may also act as a Charging Transfer Function (CTF). A CTF generates charging events toward the Charging Function (CHF), which is responsible for generating Charging Data Records (CDRs) for determining how a UE is to be charged for being provided with various services. Each PDU session is assigned a unique identity number by the SMF for billing purposes. The charging identifier correlates charging information between the SMF and CHF for the duration of a PDU session. The SMF generates and assigns a charging identifier when a PDU session is established. The charging identifier is unique for that PDU session and is used in all messages that are exchanged in that PDU session.

The SMF collects the following charging information for converged online and offline charging (e.g., charging that may comprise a mixture of online charging and offline charging):
Usage of access and core network resources: Describes the amount of data that is delivered to and forwarded from the UE.
Usage duration: Time interval from PDU Session Establishment to PDU Session Release.
User: UE information used by the user for a PDU session.
Data network: Data network address as determined by the DNN.
Start time: PDU session start time.
User location: home network (e.g., Home PLMN) and visited network (e.g., VPLMN) reporting area.

At least some of this information may be provided to the charging function as part of a charging event. The fulfilment of criteria (e.g., “trigger conditions”) that are associated with at least one charging event may cause the SMF to signal a charging event to the CHF. Some example trigger conditions are detailed in Table 5.2.4.1 of 3GPP TS 32.255, and relate to at least two different types of charging requests: Charging Data Request [Initial]; and Charging Data Request [Update].

According to the presently described system, the SMF may additionally trigger a charging event in respect of a session based on at least one charging event trigger that relates to the presently described energy behaviour category. These are illustrated below in Table 8.

TABLE 8
Default trigger conditions in SMF

| | | Converged | Offine only | CHF | CHE | Message when |
|---|---|---|---|---|---|---|
| | | Charging | charging | allowed to | allowed to | “immediate |
| Trigger | Trigger | default | default | change | enable and | reporting” |
| Conditions | level | category | category | category | disable | category |
| Start of the | RG | Immediate | No | No | No | Charging |
| Service | | | | | | Data |
| Data Flow | | | | | | Request |
| with an | | | | | | [Initial] |
| Energy | | | | | | |
| Behaviour | | | | | | |
| Category | | | | | | |
| Change of Charging conditions | | | | | | Charging |
| Energy | PDU | Immediate | Deferred | Yes | Yes | Data |
| Behaviour | session/ | | | | | Request |
| Category | RG | | | | | [Update] |
| change | | | | | | |
| Quota management Request | | | | | | |
| Energy | RG | Immediate | Not | No | Yes | |
| Behaviour | | | applicable | | | |
| Category | | | | | | |
| Change | | | | | | |

Once a charging event has been triggered, the SMF may perform at least one action. These are illustrated below in Table 9, with the conditions and actions being presently proposed in relation to the user energy behaviour category being in bold.

TABLE 9
Chargeable events and their related actions in SMF

| Chargeable | | |
|---|---|---|
| event | Conditions | SMF action |
| Start of | | Charging Data Request [Initial] |
| PDU | | with a possible request quota for |
| session | | later use. |
| Start of | If quota management is required, | Charging Data Request [Update] |
| service | and valid quota for this rating group | to request quota with a possible |
| data | does not exist | amount of quota. |
| flow | If service identifier level reporting | Start new counts with time stamps |
| | is required by the PCC rule | for the combination of the rating |
| | | group and service id |
| | If rating group level reporting is | Start new counts with time stamps |
| | required by the PCC rule | for the rating group |
| | If sponsored connectivity level | Start new counts with time stamps |
| | reporting is required by the PCC | for the combination of the rating |
| | rule | group, sponsor identity and |
| | | application service provider |
| | | identity |
| | If charging resource, e.g., charging | Charging Data Request [Initial] |
| | session, for the PDU session does | with a possible request quota |
| | not exist | |
| | If Rating Group level reporting is | Charging Data Request [Initial] |
| | specified when Energy Behaviour | with a possible request quota |
| | category is used by the PCC rule | |
| | If Rating Group level reporting is | Charging Data Request |
| | specified by at least one PCC rule | [Update] to request quota with a |
| | and Energy Behaviour category | possible amount of quota. |
| | changes | |

As mentioned above, an AF can get information on a user energy behaviour category of at least one UE and/or at least one group of UEs (assuming the privacy and permission policies of the UE(s) and/or AF allow for this). The AF may also subscribe to changes of such a user energy behaviour category for the subscribers for which the AF is allowed to retrieve data (e.g., from an NWDAF).

To enable this, a set of application program interfaces (APIs) may be exposed to AF so they can access to information about the current list of energy behaviours categories supported by at least one network operator, and about details related to a specific energy behaviour category (e.g., a number of UEs within each category, details about the category metrics such as related behaviour, associated energy consumption ranges, etc.). Accessing the list of categories allows an AF to map a specific category retrieved for a UE with the behaviour of other UEs. This may be for stimulating at least one energy-based behavioral changes, either based on UE-based action or by an AF-based action.

The AF may also leverage the energy behaviours categories as “Internal/external Group ID” or “External Subscriber category” in existing NEF API requests when targeting a group of UEs. For example, an AF could offer some data connectivity to only category “A” UEs during a green marketing campaign.

Based on the user energy behaviour category (or notification of change in this user energy behaviour category), an NF and/or AF may signal a user of the UE to communicate the UE's energy behaviour category. This may be performed using, for example, a short-message-service (SMS) message. This signalling may comprise an explanation of this category and/or provide further information on how to change UE and/or user behaviour to move to a more energy efficient category. In another example, the user energy behaviour category (with or without the explanation and/or further information) may be signalled to the UE at the time of PDU Session Establishment (e.g., using non access stratum, NAS, signalling). The explanation and/or recommendation can be predefined static information or contain dynamic yet personalized information (e.g., main impacting features, such as time, speed, location, etc.).

As an example, based on calculations on the provided statistics, an AF can send a message to the UE saying that the UE belongs to top 23% of the subscribers with respect to energy friendly behaviour, and/or offering a user of the UE some discount if the UE moves to a more energy efficient category by the end of a specified time duration. The user of the UE may change their behaviour in response to seeing this information. This change may result in the UE behaving in a more energy efficient manner. The UE may additionally or alternatively autonomously perform an action that results in the UE performing in a more energy efficient manner in response to receiving the indication of the user energy behaviour category.

FIGS. 6 to 11 illustrate features of the above examples from the perspective of apparatus. It is therefore understood that features of the below FIGs. may find correspondence with features mentioned in the above examples. It is further understood that the above examples may illustrate features of the below.

FIG. 6 illustrates operations that may be performed by an apparatus. The apparatus may be comprised in an analytics function. For example, the apparatus may be comprised in a network data analytics function. The apparatus may be comprised in a charging function.

During 601, the apparatus maps an energy behaviour category to a user equipment, wherein the energy behaviour category is an energy behaviour category of a plurality of energy behaviour categories defined by a network operator that categorizes how energy efficiently an apparatus is behaving. The mapping may be performed in response to receiving a request to map the user equipment to an energy behaviour category. The mapping may be performed autonomously by the apparatus (e.g., without receiving a specific request to perform the mapping). The mapping may be performed periodically, and/or aperiodically by the apparatus.

During 602, the apparatus provides an indication of the mapped energy behaviour category to a requesting network function. The indication may be provided with an identifier that identifies the user equipment. The providing may be performed in response to receiving a request for the indication from the requesting network function.

The requesting network function may comprise at least one of: a policy control function, a charging function, a session management function, or an access and mobility management function. The apparatus may receive a request for the mapped energy behaviour category for the user equipment.

The apparatus may receive at least one of an identifier of the user equipment or an identifier of a group of user equipment that comprises the user equipment. This identifier may be received in the request for the mapped energy behaviour category received from the requesting network function.

The apparatus may further receive, in the request from the requesting network function, an indication of at least one of: an indication of a time period to which the energy behaviour category relates; an indication of an analytics accuracy level to be complied with when determining the energy behaviour category; or an indication of an analytics granularity level to be complied with when determining the energy behaviour category. The apparatus may use the received indication to perform analytics that determines the mapped energy behaviour category.

The apparatus may use the mapped energy behaviour category to adjust at least one charging policy associated with a session of the user equipment.

The using the mapped energy behaviour to adjust the at least one charging policy comprises may comprise: using the mapped energy behaviour category to look up at least one energy credit charging policy associated with the mapped energy behaviour category; and adjusting at least one charging policy to comply with the at least one energy credit charging policy.

The apparatus may determine at least one action that may be performed by the user equipment and/or a user of the user equipment for making the user equipment perform in a more energy efficient energy behaviour category than the determined energy behaviour category; and cause an indication of the at least one action to be signalled to the requesting network function.

FIG. 7 illustrates operations that may be performed by an apparatus. The apparatus may be comprised in a network function. The apparatus may be comprised in a PCF.

During 701, the apparatus determines whether a policy for a user equipment is to be generated based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving.

During 702, the apparatus provides, to a network function at least one policy for the user equipment determined in dependence on the determined energy behaviour category. The network function may be requesting policies for at least one service being provided to the user equipment. The network function may comprise an AMF. The network function may comprise an SMF. The network function may comprise a CHF.

The determining whether a policy is to be generated based on the energy behaviour category may comprise: retrieving at least one of: an indication of an energy behaviour category associated with the user equipment, or an indication of a network slice; and using the retrieved indication to perform the determining. The retrieved indication may be retrieved from a unified data management.

When the network function comprises a session management function, the at least one policy provided to a session management function may comprise an indication that at least one policy for the user equipment is based on the energy behaviour category associated with the user equipment or group of user equipments.

The apparatus may receive the energy behaviour category associated with that subscriber from an analytics function and/or from a charging function. The analytics function and/or charging function may comprise an apparatus as described above in relation to FIG. 6.

The apparatus may receive the energy behaviour category in response to the apparatus signalling a request to the analytics function and/or charging function to receive an indication of the energy behaviour category of the user equipment. The apparatus may receive the energy behaviour category autonomously from the analytics function and/or charging function (e.g., not in response to the apparatus signalling a request for this indication).

The apparatus may provide a session management function with the received energy behaviour category associated with that subscriber. This providing may be performed when the apparatus provided the at least one policy to the session management function.

FIG. 8 illustrates operations that may be performed by an apparatus. The apparatus may be comprised in a network function. The apparatus may be comprised in an SMF.

During 801, the apparatus receives, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving.

During 802, the apparatus enforces, for a session associated with the user equipment, at least one policy that complies with the energy behaviour category associated with that subscriber.

The apparatus may receive the energy behaviour category associated with the user equipment from a policy and control function. The energy behaviour category may be received from the PCF with at least one policy relating to a session of the user equipment.

The apparatus may receive the energy behaviour category associated with the user equipment from a charging function and/or an analytics function. This may be as described above in relation to FIG. 6 and/or FIG. 7.

The apparatus may select a user plane function for the user equipment using the energy behaviour category associated with the user equipment. The selected UPF may be used for routing user plane and/or data communications for the user equipment to and/or from the user equipment.

The apparatus may modify a session management policy based on the energy behaviour category associated with the user equipment. Stated differently, a session management policy for a user equipment may vary with a change in an energy behaviour category associated with the user equipment.

The apparatus may insert the energy behaviour category associated with the user equipment into at least one charging data request, and signal the at least one charging data request to a charging function.

The network function may be at least one of a policy and control function, a charging function, and a network analytics function.

FIG. 9 illustrates operations that may be performed by an apparatus. The apparatus may be comprised in a network function. The apparatus may be comprised in a charging function.

During 901, the apparatus obtains, an indication of an energy behaviour category associated with a user equipment, wherein the energy behaviour category is an energy behaviour category of a plurality of energy behaviour categories defined by a network operator that categorizes how energy efficiently an apparatus is behaving. The obtaining may be performed by the apparatus performing at least one data analytics function. The obtaining may be performed by receiving the energy behaviour category from an SMF. The obtaining may be performed by receiving the energy behaviour category from a PCF. The obtaining may be performed by receiving the energy behaviour category from a network analytics function.

During 902, the apparatus uses the energy behaviour category associated with the user equipment to determine a charging policy for the user equipment.

The obtaining may comprise: receiving the energy behaviour category associated with that subscriber from a session management function and/or from an analytics function, and/or from a policy control function.

The using the mapped energy behaviour to determine the at least one charging policy may comprise: using the energy behaviour category to look up at least one energy credit charging policy associated with the mapped energy behaviour category; and setting at least one charging policy to comply with the at least one energy credit charging policy.

The apparatus may determine at least one action that may be performed by the user equipment and/or a user of the user equipment for making the user equipment perform in a more energy efficient energy behaviour category than the determined energy behaviour category; and cause an indication of the at least one action to be signalled to the user equipment.

FIG. 10 illustrates operations that may be performed by an apparatus. The apparatus may be comprised in a network function. The apparatus may be comprised in a network exposure function. The operations may be performed by an application being run on the apparatus. The operations may be comprised in an application function.

During 1001, the apparatus receives, from a network function, an indication that a first set of user equipment of a plurality of user equipment are associated with a first energy behaviour category, and an indication that a second set of user equipment of the plurality of user equipment are associated with a second energy behaviour category, wherein an energy behaviour category is an energy behaviour category of a plurality of energy behaviour categories defined by a network operator that categorizes how energy efficiently an apparatus is behaving and wherein the second energy behaviour category is more energy efficient than the first energy behaviour category. This receiving may be performed in response to the apparatus transmitting a request for the first energy behaviour category. The receiving may be performed autonomously (e.g., not in response to the apparatus transmitting a request for the first energy behaviour category).

During 1002, the apparatus causes the first set of user equipment to change their operating configuration to cause the first set of user equipment to operate more energy efficiently.

The first set may comprise one or more user equipment. The first set may comprise a plurality of user equipment. The second set may comprise one or more user equipment. The second set may comprise a plurality of user equipment.

The apparatus may determine that the operation of the first set of user equipment has changed to an extent that the first set of user equipment are associated with the second energy behaviour category. This determination may be performed subsequent to the apparatus causing the first set of user equipment to change their operating configuration.

FIG. 11 illustrates operations that may be performed by an apparatus. The apparatus may be comprised in a user equipment. The user equipment may be comprised in the first set of user equipment of FIG. 10.

During 1101, the apparatus receives, from a network function, an indication that the apparatus is operating in accordance with a first energy behaviour category, wherein an energy behaviour category is an energy behaviour category of a plurality of energy behaviour categories defined by a network operator that categorizes how energy efficiently an apparatus is behaving.

During 1102, the apparatus causes a change in operating configuration at the apparatus in response to said receiving. The network function may correspond to an entity that performs the operations of the apparatus of FIG. 10.

The causing the change may comprise: causing an output to be displayed to a user of the apparatus that indicates at least one of: the first energy behaviour category, or at least one mechanism by which the operations of the apparatus may be performed more energy efficiently; subsequently determining that a behaviour of the user has changed; and providing an indication of the change in behaviour to a network.

The causing the change may comprise: receiving an indication of a change to at least one operating characteristic of the apparatus; and causing the change to the at least one operating characteristic to be performed.

In the above, different examples are described using, as an example of an access architecture to which the described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

As provided herein, various aspects are described in the detailed description of examples and in the claims. In general, some examples may be implemented in hardware or special purpose circuits, software code, logic or any combination thereof. For example, some aspects may be implemented in hardware, while other aspects may be implemented in firmware or software code which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software code, firmware code, special purpose circuits or logic, general purpose hardware or controller or other computing devices, or some combination thereof.

The examples may be implemented by computer software code stored in a memory and executable by at least one data processor of the involved entities or by hardware, or by a combination of software code and hardware.

The memory referred to herein may be of any type suitable to the local technical environment and may be implemented using any suitable data storage technology, such as semiconductor based memory devices, magnetic memory devices and systems, optical memory devices and systems, fixed memory and removable memory.

The (data) processors referred to herein may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Further in this regard it should be noted that any procedures, e.g., as in FIG. 6, and/or FIG. 7, and/or FIG. 8, and/or FIG. 9, and/or FIG. 10, and/or FIG. 11, and/or otherwise described previously, may represent operations of a computer program being deployed by at least one processor comprised in an apparatus (where a computer program comprises instructions for causing an apparatus to perform at least one action, the instructions being represented as software code stored on at least one memory), or interconnected logic circuits, blocks and functions, or a combination of operations of a computer program being deployed by at least one processor comprised in an apparatus and logic circuits, blocks and functions. The software code may be stored on memory, such as physical media as memory chips, or memory blocks implemented within the processor, magnetic media (such as hard disk or floppy disks), and optical media (such as for example DVD and the data variants thereof, CD, and so forth).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multicore processor architecture, as nonlimiting examples.

Additionally or alternatively, some examples may be implemented using circuitry. The circuitry may be configured to perform one or more of the functions and/or method steps previously described. That circuitry may be provided in the base station and/or in the communications device and/or in a core network entity.

As used in this application, the term “circuitry” or “means” may refer to one or more or all of the following:
(a) hardware-only circuit implementations (such as implementations in only analogue and/or digital circuitry);
(b) combinations of hardware circuits and software cade, such as:
   (i) a combination of analogue and/or digital hardware circuit(s) with software/firmware code and
   (ii) any portions of hardware processor(s) with software code (including digital signal processor(s)), software code, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software code (e.g., firmware) for operation, but the software code may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware code. The term circuitry also covers, for example integrated device.

FIGS. 2 and 3 illustrate examples of how different apparatus may be implemented for a 5GS.

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR, and so forth. The control apparatus may be integrated with or external to a node or module of a core network or RAN. In some examples, base stations comprise a separate control apparatus unit or module. In other examples, the control apparatus can be another network element, such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example, the control apparatus 200 or processor 201 can be configured to execute an appropriate software code to provide the control functions. References to “code” herein are understood to refer to software code, and vice versa.

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is referred to as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication or may not need human interaction for communication. As described herein, the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally or externally to the wireless device.

A wireless device is typically provided with at least one data processing entity 301, at least one memory 302 and other possible components 303 for use in software code and hardware aided execution of Tasks it is designed to perform, including control of access to and communications with access systems and other communication devices. The data processing, storage and other relevant control apparatus can be provided on an appropriate circuit board and/or in chipsets. This feature is denoted by reference 304. The user may control the operation of the wireless device by means of a suitable user interface such as keypad 305, voice commands, touch sensitive screen or pad, combinations thereof or the like. A display 308, a speaker and a microphone can be also provided. Furthermore, a wireless communication device may comprise appropriate connectors (either wired or’ wireless) to other devices and/or for connecting external accessories, for example hands-free equipment, thereto.

Implementations of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “non-transitory,” as used herein, is a limitation of the medium itself (i.e., tangible, not a signal) as opposed to a limitation on data storage persistency (e.g., RAM vs. ROM).

The scope of protection sought for various examples of the disclosure is set out by the independent claims. The examples and features, if any, described in this specification that do not fall under the scope of the independent claims are to be interpreted as examples useful for understanding the disclosure.

The foregoing description has provided by way of non-limiting examples a full and informative description of example implementations of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further implementation comprising a combination of one or more implementations with any of the other implementations previously discussed.

1. An apparatus comprising:
at least one processor; and
at least one memory storing instructions of a network data analytics function or a charging function of a communication network, wherein the instructions, when executed by the at least one processor, cause the apparatus to perform operations, the operations comprising:
mapping an energy behaviour category to a user equipment, wherein the energy behaviour category is an energy behaviour category of a plurality of energy behaviour categories defined by a network operator that categorizes how energy efficiently an apparatus is behaving; and
providing an indication of the mapped energy behaviour category to a requesting network function.

2. The apparatus as claimed in claim 1, wherein the operations further comprise:
receiving at least one of an identifier of the user equipment or an identifier of a group of user equipment that comprises the user equipment;
receiving a request from the requesting network function, the request comprising at least one of:
an indication of a time period to which the energy behaviour category relates;
an indication of an analytics accuracy level to be complied with when determining the energy behaviour category; or
an indication of an analytics granularity level to be complied with when determining the energy behaviour category; and
using the indication to perform analytics that determines the mapped energy behaviour category.

3. The apparatus as claimed claim 1, wherein the operations further comprise:
using the mapped energy behaviour category to adjust at least one charging policy associated with a session of the user equipment.

4. The apparatus as claimed in claim 3, wherein the means for using the mapped energy behaviour to adjust the at least one charging policy comprises means for performing:
using the mapped energy behaviour category to look up at least one energy credit charging policy associated with the mapped energy behaviour category; and
adjusting at least one charging policy to comply with the at least one energy credit charging policy.

5. The apparatus as claimed in claim 1, wherein the operations comprise:
determining at least one action that may be performed by the user equipment and/or a user of the user equipment for making the user equipment perform in a more energy efficient energy behaviour category than the determined energy behaviour category; and
causing an indication of the at least one action to be signalled to the requesting network function.

6. The apparatus as claimed in claim 1, wherein the requesting network function comprises at least one of: a policy control function, a charging function, a session management function, or an access and mobility management function.

7. An apparatus comprising:
at least one processor; and
at least one memory storing instructions of a policy control function of a communication network, wherein the instructions, when executed by the at least one processor, cause the apparatus to perform operations, the operations comprising:
determining whether a policy for a user equipment is to be generated based on an energy behaviour category associated with the user equipment, wherein the energy behaviour category is an energy behaviour category of a plurality of energy behaviour categories defined by a network operator that categorizes how energy efficiently an apparatus is behaving; and
providing, to a network function, at least one policy for the user equipment determined in dependence on the determined energy behaviour category, wherein the network function comprises an access and mobility function, a session management function, or a charging function.

8. The apparatus as claimed in claim 7, wherein the determining whether a policy is to be generated based on the energy behaviour category comprises:
retrieving at least one of: an indication of an energy behaviour category associated with the user equipment, or an indication of a network slice; and
using the retrieved indication to perform the determining.

9. The apparatus as claimed in claim 7, wherein the network function comprises a session management function, and wherein the at least one policy provided to a session management function comprises an indication that at least one policy for the user equipment is based on the energy behaviour category associated with the user equipment or a group of user equipments.

10. The apparatus as claimed in claim 7, wherein the operations further comprise:
receiving the energy behaviour category associated with that subscriber from an analytics function and/or from a charging function.

11. The apparatus as claimed in claim 10, wherein the operations further comprise:
providing a session management function with the received energy behaviour category associated with that subscriber.

12. An apparatus comprising:
at least one processor; and
at least one memory storing instructions of a session management function, wherein the instructions when executed by the at least one processor, cause the apparatus to perform operations, the operations comprising:
receiving, from a network function, an indication that a policy for a user equipment is based on an energy behaviour category associated with the user equipment or with a group of user equipments that comprises the user equipment, wherein the energy behaviour category is an energy behaviour category of a plurality of energy behaviour categories defined by a network operator that categorizes how energy efficiently an apparatus is behaving, wherein the network function is a policy and control function, a charging function, or a network analytics function; and
enforcing, for a session associated with the user equipment, at least one policy that complies with the energy behaviour category associated with that subscriber.

13. The apparatus as claimed in claim 12, wherein the operations further comprise:
receiving the energy behaviour category associated with the user equipment from a policy and control function.

14. The apparatus as claimed in claim 12, wherein the operations further comprise:
receiving the energy behaviour category associated with the user equipment from a charging function and/or an analytics function.

15. The apparatus as claimed in claim 12, wherein the operations further comprise:
selecting a user plane function for the user equipment using the energy behaviour category associated with the user equipment.

16. The apparatus as claimed in claim 12, wherein the operations further comprise:
modifying a session management policy based on the energy behaviour category associated with the user equipment.

17. The apparatus as claimed in claim 12, wherein the operations further comprise:
inserting the energy behaviour category associated with the user equipment into at least one charging data request; and
signalling the at least one charging data request to a charging function.

18. An apparatus comprising:
at least one processor;
at least one memory storing instructions of a charging function of a communication network, wherein the instructions when executed by the at least one processor, cause the apparatus to perform operations, the operations comprising:
obtaining, an indication of an energy behaviour category associated with a user equipment, wherein the energy behaviour category is an energy behaviour category of a plurality of energy behaviour categories defined by a network operator that categorizes how energy efficiently an apparatus is behaving; and
using the energy behaviour category associated with the user equipment to determine a charging policy for the user equipment.

19. The apparatus as claimed in claim 18, wherein the obtaining comprises:
receiving the energy behaviour category associated with that subscriber from at least one of: session management function; an analytics function; or a policy control function.

20. The apparatus as claimed in claim 19, wherein the using the mapped energy behaviour to determine the at least one charging policy comprises:
using the energy behaviour category to look up at least one energy credit charging policy associated with the mapped energy behaviour category; and
setting at least one charging policy to comply with the at least one energy credit charging policy.

21. The apparatus as claimed in claim 20, wherein the operations further comprise:
determining at least one action that may be performed by the user equipment and/or a user of the user equipment for making the user equipment perform in a more energy efficient energy behaviour category than the determined energy behaviour category; and
causing an indication of the at least one action to be signalled to the user equipment.
